(19) United States
(12) Patent Application Publication
(10) Pub. No.: US 2022/0354137 A1
(43) Pub. Date: Nov. 10, 2022

(54) SUPPORT ELEMENT FOR PORTIONS OF MEAT

(71) Applicant: FAVA S.N.C. DI ADELE TURETTA & C., Parma (PR) (IT)

(72) Inventor: Antonio Fava, Parma (PR) (IT)

(21) Appl. No.: 17/731,734

(22) Filed: Apr. 28, 2022

(30) Foreign Application Priority Data
May 4, 2021 (IT) 102021000011303

(51) Int. Cl. A22C 15/00

(52) U.S. Cl. CPC A22C 15/005

(57) ABSTRACT

A support element (45a,45b,45c,45d,45e,45f,45g,45h,45i,45l,45m,45n) is described for a portion of meat (10), adapted to hook said portion of meat and to allow the handling of said portion of meat, said support element comprising: a bar (50a,50b,50c,50d,50e,50f,50g,50h,50i,50l,50m,50n) developing longitudinally along a longitudinal axis (X), a plurality of straight needles (55), adapted to penetrate the portion of meat (10), arranged with longitudinal axes (K) parallel to each other and arranged in a row parallel to the longitudinal axis (X), a connection body (60a,60b,60c,60d,60e) connecting the straight needles to the bar and comprising a first face (65a,65b,65c,65d,65e), from which said needles (55) rise, and a second face (70a,70b,70c,70d,70e) facing in the opposite direction to the first face. Wherein said support element comprises: a grasping appendage (75a,75b,75c,75d,75e), which rises from a portion of the second face (70a,70b,70c,70d,70e) proximal to the needles (55) and develops both in a direction away from the first face and from the second face and in a longitudinal direction parallel to the longitudinal axis (X) of the bar (50a,50b,50c,50d,50e,50f,50g,50h,50i,50l,50m,50n). Wherein said grasping appendage (75a,75b,75c,75d,75e) is rigidly integral with the second face (70a,70b,70c,70d,70e) in at least a plurality of side-by-side sections along said longitudinal direction along which the grasping appendage develops, and wherein there is at least one of said sections every two consecutive needles (55).

### TECHNICAL FIELD

The invention belongs to the technical field of plants for processing portions of meat, for example bacon, wherein said portions of meat are, for example, cured and/or frozen and/or smoked and/or cooked and/or chilled.

More specifically, the present invention relates to a support element for such portions of meat.

### PRIOR ART

There are known plants for processing portions of meat, for example cuts of meat of elongated and irregular shape in which two dimensions (width and height) are prevalent with respect to a third dimension (thickness). A typical cut of meat of that type is bacon.

These plants comprise stations for processing portions of meat, for example smoking stations, salting stations, seasoning stations, cooking stations, refrigeration/freezing stations, etc. In particular, plants for processing bellies generally comprise at least one smoking station and a refrigeration/freezing station.

The portions of meat are moved within the processing stations by acting on support elements to which the portions of meat are attached.

A known embodiment of such support elements comprises an elongated shaped bar to which, by means of a connection body, for example in the form of a flat plate, a plurality of needles are connected, rising from a face of said support body, in particular from a portion distal from the bar of said face.

The bar is used as a hold for the movement of the support element along the plant, while the needles are configured to penetrate the portion of meat and to hold it vertically hanging therefrom.

Once processing of the portions of meat has been completed, they must be detached, i.e. released, from the support elements by means of a device for unloading the portions of meat. In practice, at this stage the portions of meat must be removed from the needles of their support elements. This can be very complicated when the portions of meat are rigid, for example as a result of smoking and/or freezing.

A known solution for releasing the portions of meat thus processed from the support elements provides for an apparatus for unloading the portions of meat, which is equipped with a striker surface in contact with which a portion of meat is placed by moving the support element with a special support element handling unit. Specifically, the support element is moved by placing in contact with the striker surface a face of the portion of meat that directly contacts a portion of the face of the connection body from which the needles rise. When the portion of meat is in such position, the bar of the support element is pushed by the handling unit away from the striker surface, along a direction transversal to the striker surface, and at the same time a pad is pushed against the face of the connection body from which the needles rise, in a portion of said face comprised between the needles and the bar and proximal to the bar, always in a direction away from the striker surface. In this way, the support element is detached/removed from the portion of meat, since the portion of meat cannot advance together with the support element in the direction in which it is pushed by the support apparatus by the handling unit, and especially by the pad, due to contact with the striker surface.

This solution is not without drawbacks. In particular, although the pad is configured to act in a portion of the connection body proximal to the bar, which should be free from the portion of meat, since the shape of such portions of meat is not always regular, it may occur that if a portion of meat protrudes towards the bar more than normal, when the pad is actuated this excessively protruding portion of meat remains squashed between the pad and the connection body, thus preventing the support element from being detached from the portion of meat. Making longer connection bodies of the support elements so that the needles are further away from the bar is not an easy solution, as this would increase the weight of the support elements, which would have an impact on the energy required to move the support elements along the plant (which are generally several thousand in number), as well as on the costs of making the support elements themselves.

Another problem is that acting on the connection body near the bar requires a high force, particularly if the piece of meat is rigid, in order to allow the needles to be removed from the portion of meat. Consequently, to withstand these strains, the support elements have to be very thick, which makes them particularly heavy. This has an impact on the energy required to move the support elements along the plant, as well as the manufacturing costs.

The object of the present invention is to overcome the limits of the prior art in the context of a rational and low-cost solution. This object is achieved by the features of the invention indicated in the independent claim. The dependent claims outline preferred and/or particularly advantageous aspects of the invention.

### DISCLOSURE OF THE INVENTION

In particular, the invention makes available a support element for a portion of meat, adapted to allow the handling of said portion of meat comprising:
a bar developing longitudinally along a longitudinal axis,
a plurality of straight needles, adapted to penetrate the portion of meat, arranged with longitudinal axes parallel to each other and arranged in a row parallel to the longitudinal axis, and
a connection body connecting the straight needles to the bar and comprising a first face, from which said needles rise, and a second face facing in the opposite direction to the first face,
   said support element being characterised in that it comprises:
a grasping appendage, which rises from a portion of the second face proximal to the needles and develops both in a direction away from the first face and from the second face and in a longitudinal direction parallel to the longitudinal axis of the bar,
   wherein said grasping appendage is rigidly integral with the second face in at least a plurality of side-by-side sections along said longitudinal direction along which the grasping appendage develops, and wherein there is at least one of said sections every two consecutive needles.

This solution provides a support element configured to be pulled or held in place, rather than pushed, during the step of extracting the portion of meat, which avoids the problems of the prior art due to the possible overlapping of the portions of meat on the first face. Furthermore, the positioning of the appendage in a portion of the second face proximal to the needles and the distribution of the sections over a high longitudinal portion of the appendage, being one at least every two, allows for a better distribution of the force applied to the support element, compared to the prior art, consequently the support elements according to the invention, in particular the connection bodies of the support elements, can be less thick and therefore lighter and less long/expensive to process, and more compact for the same weight of the portions of meat to be supported, compared to known support elements.

According to an aspect of the invention, the portion of the second face from which the grasping appendage rises may be made in proximity to a plane on which the longitudinal axes of the needles lie.

This makes it possible to further reduce the thicknesses of the support body, as the force to be applied to pull the appendage is essentially in axis with the needles, a factor that makes it possible to minimize the generation of bending forces in the connection body.

Another aspect of the invention, according to which said portion of the second face from which the grasping appendage rises can intersect the laying plane of the longitudinal axes of the needles, may contribute to improve this advantage.

This advantage may be further improved by another aspect of the invention, according to which the direction away from the needles along which the grasping appendage develops may be parallel to the longitudinal axes of the needles.

Another aspect of the invention may provide that the grasping appendage may comprise a plurality of through slots or a plurality of recesses aligned with each other along a direction parallel to the direction of the longitudinal axis. In this way, the element may be easily attached with a grasping body having a plurality of hooks (which for example could be part of an automated unloading apparatus for automating the extraction of the portion of meat from the needles). In addition, the fact that there is a plurality of through slots or recesses makes it possible to distribute the forces applied for extraction from the appendage more evenly.

Alternatively, the grasping appendage could be a seamless, convex body or a seamless flat plate suitable for attaching with a gripper.

Still another aspect of the invention provides that the plurality of through slots or the plurality of recesses may be made in the grasping appendage in proximity to a plane on which the longitudinal axes of the needles lie.

This makes it possible to further reduce the thickness of the support body, as the force to pull the appendage is applied in an area essentially in axis with the needles, a factor that makes it possible to minimize the generation of bending forces, both in the connection body and in the appendage.

The invention may also provide that the bar may comprise a pair of opposing longitudinal ends, each of which comprises:
either a flat surface lying in a plane parallel to the longitudinal axis and having a length in a direction transverse to the longitudinal axis at least equal to 0.6 times the length of a needle of the plurality of needles measured along the longitudinal axis of the needle,
or a pair of surfaces which lie or are tangent to a same plane parallel to the longitudinal axis and are spaced apart from each other along a direction transverse to the longitudinal axis by an amount at least equal to 0.6 times the length of a needle of the plurality of needles measured along the longitudinal axis of the needle,
or a pair of edges lying in the same plane parallel to the longitudinal axis and are spaced apart along a direction transverse to the longitudinal axis by an amount at least equal to 0.6 times the length of a needle of the plurality of needles measured along the longitudinal axis of the needle.

Such alternative characteristics all allow to make available a support element which, when transported by means of an automatic handling unit, does not vary its inclination according to the thickness of the portion of meat which is hooked onto it, and consequently allows to facilitate the extraction of the bacon by automated means, since there is no rotation of the appendage with respect to the longitudinal axis of the bar, as may instead occur in the case in which the ends of the bar are formed by a round body, see explanatory FIGS. 27 to 34. In particular, such a rotation may occur because, in the case of automated extraction of the portions of meat, the support elements with the portions of meat attached are moved by means of transport means, for example a pair of chains, which support the lower longitudinal ends of the bar of the support element, essentially defining flat transport surfaces on which the ends rest.

These transport means move the support elements in proximity to a gripping unit that acts on the appendage by grasping it and then pulling it to remove the portion of meat that cannot follow the movement of its support element because it is stopped by a striker surface. When the ends of the bar are round, the positioning of the grasping appendage is optimal for the gripping unit only within a narrow range of thicknesses of the portion of meat (thickness measured in the longitudinal direction of the needles). When greater variations in thickness occur, the bar tends to rotate on the transport surface (this would also happen if the bar ends were inserted into a seat, not just if they were resting on a plane) due to the displacement of the centre of gravity of the portion of meat with respect to the optimal centre of gravity position, so that the appendage gripping unit is unable to grasp the appendage effectively. By contrast, the features of the invention make it possible, thanks to the support on the transport surface in at least two points at a distance from each other in a direction transverse to the longitudinal axis of the bar, to be much less affected by variations in thickness, thus extending the range of optimal thicknesses within which the bar does not rotate and therefore the gripping unit has no difficulty in grasping the appendage.

According to another aspect of the invention, the grasping appendage may be obtained in a plurality of appendage bodies rising from the second face independently of each other.

This means that in the event of problems with deformation or breakage of one appendage body, the others are not affected and continue to be efficient. In addition, this feature allows easier repairability.

According to yet another aspect of the invention, each appendage body may comprise a through slot or a recess.

This improves the distribution of forces, especially if this is added to the possibility that the needles are made as a single body with the grasping appendage.

A further aspect of the invention may provide that each appendage body is aligned with a respective needle and the corresponding slot or recess of said appendage body intersects the longitudinal axis of said corresponding needle.

This feature further improves the distribution of forces by reducing the generation of bending moments in the grasping appendage.

The invention may also provide that the support element can be made by stamping a single sheet of sheet metal.

This characteristic makes it possible to obtain a particularly robust support element suitable for rapid series production.

### BRIEF DESCRIPTION OF THE DRAWINGS

Further features and advantages of the invention will be more apparent after reading the following description provided by way of non-limiting example, with the aid of the accompanying drawings.

FIG. 1 is a schematic side view of an apparatus for unloading portions of meat according to a first embodiment of the invention and illustrated in a resting operating position.

FIG. 2 is a schematic side view of the unloading apparatus of FIG. 1 illustrated in a subsequent operating position to that shown in FIG. 1.

FIG. 3 is a schematic side view of the unloading apparatus of FIG. 1 illustrated in a subsequent operating position to that shown in FIG. 2 and definable as the grasping operating position.

FIG. 4 is a schematic side view of the unloading apparatus of FIG. 1 illustrated in a subsequent operating position to that shown in FIG. 3 and definable as the pull-end operating position.

FIG. 5 is a schematic side view of the unloading apparatus of FIG. 1 illustrated in a subsequent operating position to that shown in FIG. 4.

FIG. 6 is a partial axonometric and schematic view of a first embodiment of a support element according to the invention and which is used in the apparatus of the preceding figures. The support element is adapted to allow a portion of meat to be hooked to itself.

FIG. 7 is a partial axonometric and schematic view of a striking body of the apparatus of the preceding figures.

FIG. 8 is a partial axonometric and schematic view of a gripping body of the apparatus of the preceding figures.

FIG. 9 is a comparison view of two operating positions that the support element and the gripping body of the apparatus of the previous figures can reach when the thickness of the portion of meat hooked to the gripping element is varied.

FIG. 10 is a schematic side view of an apparatus for unloading portions of meat according to a second embodiment of the invention and illustrated in a resting operating position.

FIG. 11 is a schematic side view of an apparatus for unloading portions of meat according to a third embodiment of the invention and illustrated in a resting operating position.

FIG. 12 is a schematic side view of an apparatus for unloading portions of meat according to a fourth embodiment of the invention and illustrated in a grasping operating position.

FIG. 13 is a plan view of the apparatus of FIG. 12.

FIG. 14 is a schematic side view of an apparatus for unloading portions of meat according to a fifth embodiment of the invention and illustrated in a grasping operating position.

FIG. 15 is a schematic side view of the apparatus of FIG. 14 illustrated in an operating position subsequent to that of FIG. 14 and definable as the end-of-thrust operating position.

FIG. 16 is a front axonometric view of a second embodiment of the support element according to the invention.

FIG. 17 is a rear axonometric view of the support element of the preceding figure.

FIG. 18 is a side view of the support element of FIGS. 16 and 17.

FIG. 19 is a front axonometric view of a third embodiment of the support element according to the invention. This embodiment of the support element is used in the apparatuses illustrated in FIGS. 12-15.

FIG. 20 is a rear axonometric view of the support element of the preceding figure.

FIG. 21 is a side view of the support element of FIGS. 19 and 20.

FIG. 22 is a front axonometric view of a fourth embodiment of the support element according to the invention.

FIG. 23 is a rear axonometric view of the support element of the preceding figure.

FIG. 24 is a side view of the support element of FIGS. 22 and 23.

FIG. 25 is a rear axonometric view of a fifth embodiment of the support element according to the invention.

FIG. 26 is a side view of the support element of FIG. 25.

FIG. 27 is a view of a comparison of three operating positions that the support element can reach, when it is moved on a flat surface and has a bar having a circular cross-section (first embodiment of the of bar according to the invention), as the thickness of the portion of meat hooked to the gripping element varies. In particular, the first image from the left of the series illustrates an optimal thickness condition, i.e. within the set range, the second image illustrates a condition where the thickness is below the optimal range and the third image on the right illustrates a condition where the thickness is above the optimal range.

FIG. 28 is a schematic side view of a second embodiment of the bar of the support element.

FIG. 29 is a schematic side view of a third embodiment of the bar of the support element.

FIG. 30 is a schematic side view of a fourth embodiment of the bar of the support element.

FIG. 31 is a schematic side view of a fifth embodiment of the bar of the support element.

FIG. 32 is a schematic side view of a sixth embodiment of the bar of the support element.

FIG. 33 is a schematic side view of a seventh embodiment of the bar of the support element.

FIG. 34 is a schematic side view of an eighth embodiment of the bar of the support element.

FIG. 35 is a schematic block view of a plant for processing portions of meat equipped with any of the of the illustrated embodiments of unloading apparatus.

### BEST MODE TO IMPLEMENT THE INVENTION

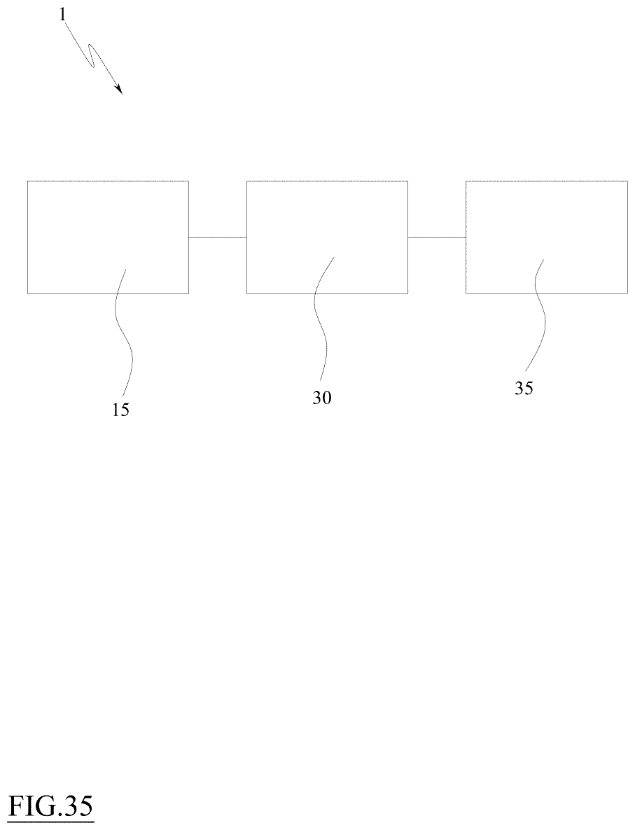

FIG. 35 shows a schematic example of an automated processing plant 1 for processing portions of meat 10 such as bacon.

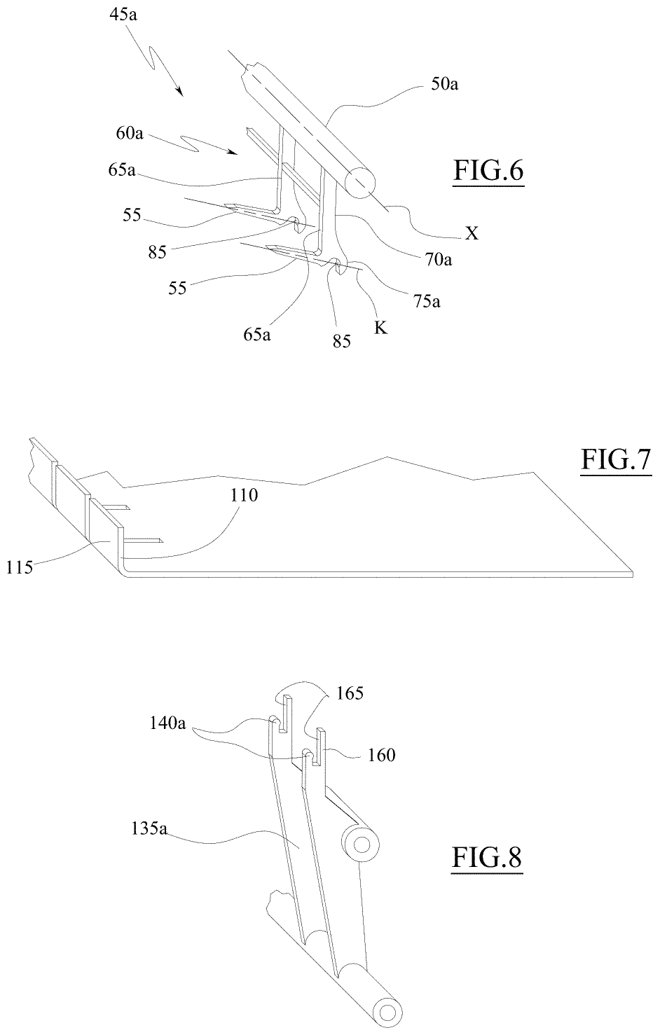

Such automated plant 1 comprises an automated loading station 15 for the portions of meat, which is configured to load, i.e. hook, the portions of meat 10 onto support elements (FIGS. 6, 16-34). In particular, as will be described below, these support elements are equipped with hooks and the loading station is configured to insert these hooks into the portions of meat to secure them to the support element.

Depending on the size of the portion of meat and the support element, i.e. the number of hooks, one or more portions of meat can be attached to a single support element.

The portions of meat are preferably elongated and irregular in shape, with two dimensions (width and height) prevailing over a third dimension (thickness), and in which it is therefore possible to identify a first greater face 20 and a second greater face 25 opposite the first face and spaced from it by an amount equal to the third dimension, i.e. the thickness. The thickness is generally not regular. A typical portion of meat of that type is bacon.

The support elements are used to move the portions of meat 10 within the processing plant. In particular, the plant may include means for moving the portions of meat through the plant that act directly on the support elements.

For example, the processing plant 1 comprises one or more processing stations 30 positioned downstream of the loading station 15 with respect to the direction of a work flow of the portions of meat 10 within the processing plant itself. For example, said processing plant 1 comprises a cooking/smoking station positioned downstream of the loading station 15 and a freezing or chilling station (positioned downstream of the smoking station).

The portions of meat 10 are moved through the smoking station and freezing or chilling station, by means of the support elements.

The plant also comprises, downstream of the processing station(s), an unloading station 35 configured to detach/unhook the portions of meat from the support elements, or in other words to slide the portions of meat off the hooks of the support element, and to direct the detached portions of meat to further processing stations, for example cutting stations, and/or packaging stations. In particular, the unloading station 35 comprises an unloading apparatus 40a,40b,40c,40d,40e configured to unhook the portions of meat from the support elements.

The figures show a plurality of embodiments of support elements 45a,45b,45c,45d,45e,45f,45g,45h,45i,45l,45m,45n adapted for the unloading apparatus according to the invention, or for at least one of the embodiments of the unloading apparatuses according to the invention. In the following, when a characteristic is common to all the apparatuses or support elements, only the number 40 and 45 will be used for brevity, respectively.

In particular, all the support elements 45 comprise a bar 50a,50b,50c,50d,50e,50f,50g,50h,50i,50l,50m,50n which develops (mainly) longitudinally along a longitudinal axis X, adapted to be directly contacted by the plant handling means (only the bar is contacted by said means for moving the support elements through the plant and the related stations), a plurality of hooks 55, preferably distributed along a row parallel to the longitudinal axis X (or a plurality of rows parallel to the longitudinal axis X), adapted to penetrate the portion of meat, and a connection body 60a,60b,60c,60d,60e connecting (directly) the hooks to the bar and comprising a first face 65a,65b,65c,65d,65e, from which said hooks of the support element, i.e. all the hooks of the support element, rise, and a second face 70a,70b,70c,70d,70e facing in the opposite direction to the first face.

In the following, when a characteristic is common or applicable to all bars or all connection bodies or all first faces or all second faces, the numbers will be simplified to 50, 60, 65 and 70.

In addition, all the support elements have in common that they are configured to be grasped and pulled or held, in order to extract/remove the hooks from the portions of meat, acting (only) at the second face 70. In particular, while the support element is being pulled or held at the second face, the portion of meat is prevented from following the trajectory imposed by this pull by a striker surface of the unloading apparatus, or the portion of meat is pushed in the direction away from the support element while the latter is held in place so as to pull the needles out, as will become clearer below.

In order to be able to be grasped and pulled from the second face, all the embodiments of the support element 45 comprise a grasping appendage 75a,75b,75c,75d,75e, possibly made in a single body with the connection body 60, which protrudes away from the second face 70 in at least one direction away from the first face (and from the second face itself).

Also for the grasping appendage, when we speak of characteristics common to all its embodiments, we shall also indicate it numerically as 75.

The gasping appendage 75 is only in contact with the second face 70, i.e. it does not contact the other elements of the support element itself. In practice, the grasping appendage comprises a free end distal from the second face 70 and from the first face 65. The grasping appendage only ever rises in the direction away from the first face.

Such distancing direction is also perpendicular to an imaginary plane on which the longitudinal axis X lies.

In more detail, the distancing direction is opposite to a direction in which the first face is facing, i.e. it is opposite to a direction towards which the hooks rise from the first face.

The grasping appendage is rigidly attached to the connection body at the second face so that forces, e.g. the pulling force, can be transferred from the appendage to the connection body and then to the hooks. The grasping appendage is also attached without residual degrees of freedom with respect to the second face of the connection body. The grasping appendage can therefore be made as a single body with the connection body (as in the embodiments shown) or it can be welded to the second face of the connection body, or it can be screwed or bolted to the second face of the connection body.

Also in all the embodiments of the support elements, in order to reduce the generation of bending moments of the connection body, therefore in order to reduce the thickness and weight of the connection body, the grasping appendage 75 rises from a portion of the second face 70 proximal to the hooks 55. More in detail, the grasping appendage rises from a portion of the second face placed at a (minimum) distance from the bar 50 substantially equal to a (minimum) distance of the portion of the first face from which the hooks rise, i.e. at least one hook (this distance being measured along a plane perpendicular to the longitudinal axis X of the bar 50).

It should be noted that substantially equal means that the (minimum) distance from the bar of the portion of the second face from which the grasping appendage rises is comprised between 0.7 and 1.3 times, preferably between 0.9 and 1.1 times the (minimum) distance from the bar of the portion of the first face from which the hooks rise, i.e. at least one hook.

Again in order to reduce the generation of bending moments in the connection body, these distances, net of manufacturing tolerances, are even more preferably equal.

These distances can also be more precisely referred to a central axis of the bar, which, depending on the conformation of the bar, can be a longitudinal axis of symmetry or a longitudinal axis passing through the centre of gravity of the bar (centre of gravity of the bar alone, isolated from the rest of the support element).

In all the embodiments of the support elements, the connection body 60, has a thickness, measured in a plane perpendicular to the longitudinal axis and along a direction perpendicular to the distance between the portion of the first face from which the hooks and the bar rise, which is very small compared to its extension from the hooks to the bar itself. For example, this thickness is less than one-third, preferably one-sixth, of the extension of the connection body comprised between the hooks 55 and the bar 50.

In order to improve the distribution of forces and to reduce the bending moments in the connection body, the grasping appendage 75 develops predominantly, in addition to the distancing direction, also in a longitudinal direction parallel to the longitudinal axis X of the bar and is rigidly integral with the second face 70 in at least a plurality of sections of the portion of the second face from which the grasping appendage itself rises, which sections are side by side along said longitudinal direction along which the appendage develops. In particular, there is at least one of said sections every two consecutive hooks.

Preferably there is at least one of said sections per hook, for example in the embodiments illustrated in Figures xx there are two lines per hook, preferably one to the right and one to the left of the hook in the longitudinal direction parallel to the axis X.

At these sections, the grasping appendage 75 is rigidly attached to the connection body and to the second face so that forces, e.g. the pulling force, can be transferred from the appendage to the connection body and to the hooks. The grasping appendage is also attached without residual degrees of freedom to the second face of the connection body at these sections. The grasping appendage in such sections can therefore be made as a single body with the connection body (as in the embodiments shown) or it can be welded to the second face of the connection body in such sections, or it can be screwed or bolted to the second face of the connection body in such sections. In other words, since in all of the illustrated embodiments the hooks, the connection body and the grasping appendage are made as a single body, it is also possible to say that all of the hooks develop from the grasping appendage, the connection body in proximity to the grasping appendage being similar to the grasping appendage itself.

It may further be said that the sum of the longitudinal extensions of said sections measured along a direction parallel to the longitudinal axis of the bar is at least equal to half a length of the row of hooks.

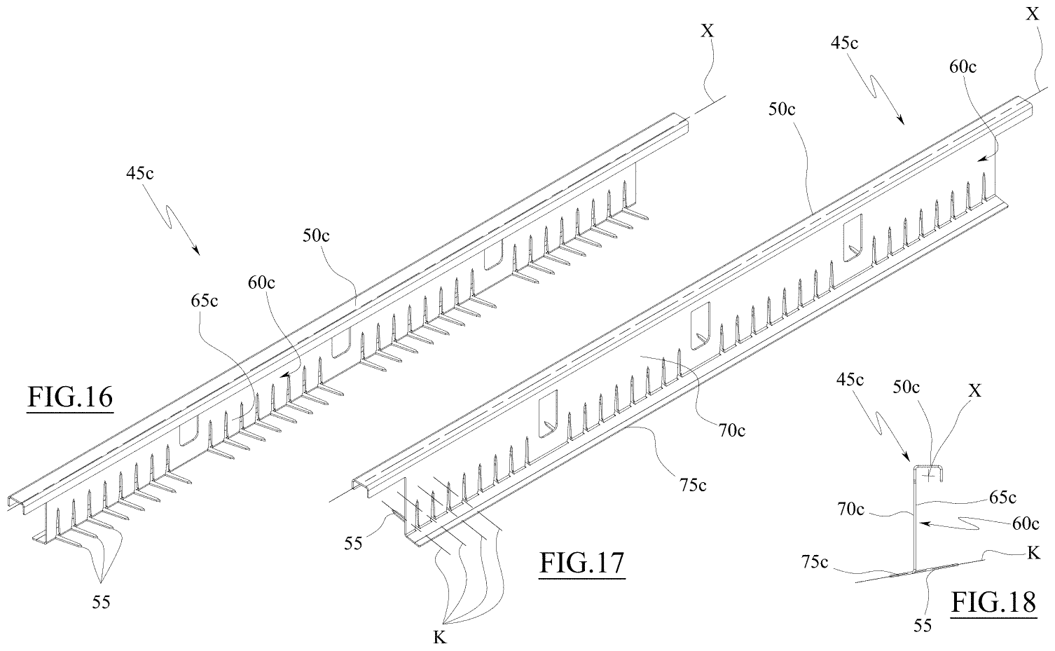

In the embodiment illustrated in FIGS. 16-18, these sections form a single continuous section extending along the whole length of the row of hooks.

In addition, in the embodiments shown, the size of the grasping appendage in the longitudinal direction shall be at least equal to half a length (measured along a direction parallel to the longitudinal axis X) of the row of hooks, preferably equal to the length of the row of hooks.

The hooks 55 are rigidly fixed without residual degrees of freedom to the first face of the connection body. For example, they can be made as a single piece with the connection body.

The hooks 55 are rigid, i.e. they cannot be bent under the normal working loads for which they are designed.

The hooks 55 are preferably shaped like straight needles rising from the first face and in particular are arranged with respective longitudinal axes K parallel to each other (and lying individually on planes perpendicular to the longitudinal axis X), for example lying together on the same plane (parallel to the longitudinal axis X).

Said straight needles are all distributed and aligned along a row parallel to the longitudinal axis X or a plurality of rows spaced apart and parallel to such longitudinal axis.

In the detail of their conformation, said straight needles comprise a base, rigidly fixed without residual degrees of freedom to the first face, from which a rod-shaped body develops along the longitudinal axis K terminating in a pointed, for example conical, end. The longitudinal axes K essentially coincide with the central axes of the rod-shaped bodies.

The longitudinal axes K of the straight needles are perpendicular to a plane on which the longitudinal axis X lies.

Also in order to reduce the bending forces, when the hooks are straight needles, the portion of the second face from which the grasping appendage rises is made close to a plane on which the longitudinal axes K of the needles lie.

For example, the minimum distance of said portion of the second face from said plane is less than 0.2 times the distance of said plane from the longitudinal axis X.

Preferably, said portion of the second face from which the grasping appendage rises intersects the laying plane of the longitudinal axes K of the needles.

In addition, the distancing direction from the needles along which it develops is parallel to the longitudinal axes K of the needles. Accordingly, if the portion of the second face, i.e. the portions of the second face, from which the grasping appendage rises is intersected by the laying plane of the longitudinal axes K and the distancing direction is parallel to that plane, the grasping appendage is intersected by the laying plane of the longitudinal axes K both at the second face and at one end of the grasping appendage distal from the second face.

Regardless of the orientation of the distancing direction, the exact position of the second face from which the grasping appendage develops, and also regardless of whether the hooks are straight needles, the grasping appendage 75a,75b,75d,75e may comprise a through slot 80 or a recess 85, for example it may comprise a plurality of through slots 80 or a plurality of recesses 85 aligned with each other along a direction parallel to the direction of the longitudinal axis X. This feature improves the grasping (presence of slots or recesses). The fact that there is a plurality of them improves the distribution of forces.

For example, for a better distribution of forces, at least one through slot or recess is provided for every two hooks 55, i.e. straight needles. In the embodiments illustrated, there is a through slot or recess for each hook 55, i.e. straight needle.

When the hooks are straight needles, the plurality of through slots or the plurality of recesses are made in the grasping appendage close to the plane on which the longitudinal axes K of the needles lie.

For example, the minimum distance of the recess or through slot from said plane is less than 0.2 times the distance of said plane from the longitudinal axis X.

Preferably, the recess or through-slot, or so-called through-slots or recesses, are intersected by the laying plane of the longitudinal axes K of the needles.

The recesses 85 are shaped like grooves. In particular, grooves that have a concave surface with an axis of curvature parallel to the longitudinal axis. Further, this concave portion comprises a first portion proximal to the second face 70a,70e and an adjoining second portion distal from the first face, and the second portion intersects the distancing direction, i.e., intersects the laying plane of the longitudinal axes K of the straight needles.

The through slots 80, which can also be described as through holes, are arranged with a respective central axis transverse to the distancing direction, for example transverse, preferably perpendicular, to the laying plane of the longitudinal axes K. In particular, each through slot 80 comprises a first portion proximal to the second face 70b,70d and a second portion distal therefrom, and the second portion intersects the distancing direction, i.e. intersects the laying plane of the longitudinal axes K of the straight needles.

In the embodiment illustrated in FIGS. 16-18, the grasping appendage 70c has no slots or recesses, i.e. it is a seamless body. For example, it is a flat seamless plate, alternatively it could be a convex seamless body.

Since this type of grasping appendage cannot be hooked for grasping, it must be grasped by means of a gripper which clamps the grasping appendage 70c.

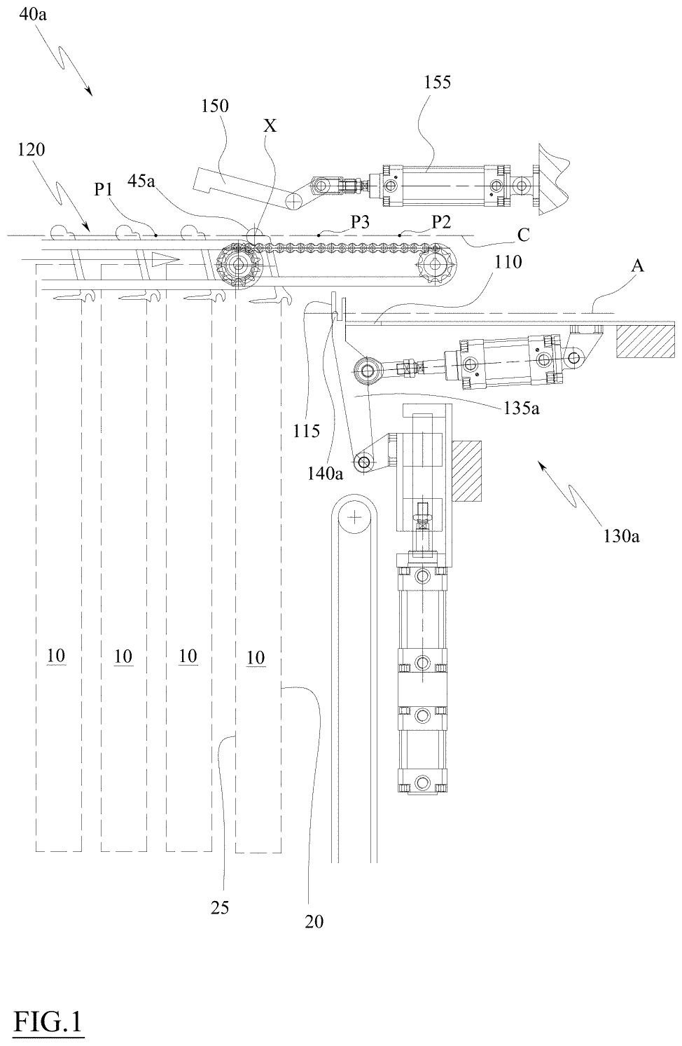

The grasping appendage may be made in a plurality of appendage bodies mechanically independent from each other, as for example in the embodiments illustrated in FIGS. 1-6,9-11,25,26. In practice, these appendage bodies are only connected to each other by their independent connection to the connection body. In other words, these appendage bodies are not directly connected or in contact with each other.

Each appendage body therefore rises independently from the others from a respective section of the second face, the second sections being spaced apart from each other.

Such appendage bodies may be aligned with each other along a direction parallel to the longitudinal axis X. In addition, two adjacent appendage bodies are separated from each other by a gap that develops from the second face.

When there are a plurality of appendage bodies, preferably each appendage body comprises a respective single through slot or a respective single recess, such as for example in the embodiment illustrated in FIGS. xx 1-6,9-11,25,26 wherein each appendage body comprises a respective recess 85.

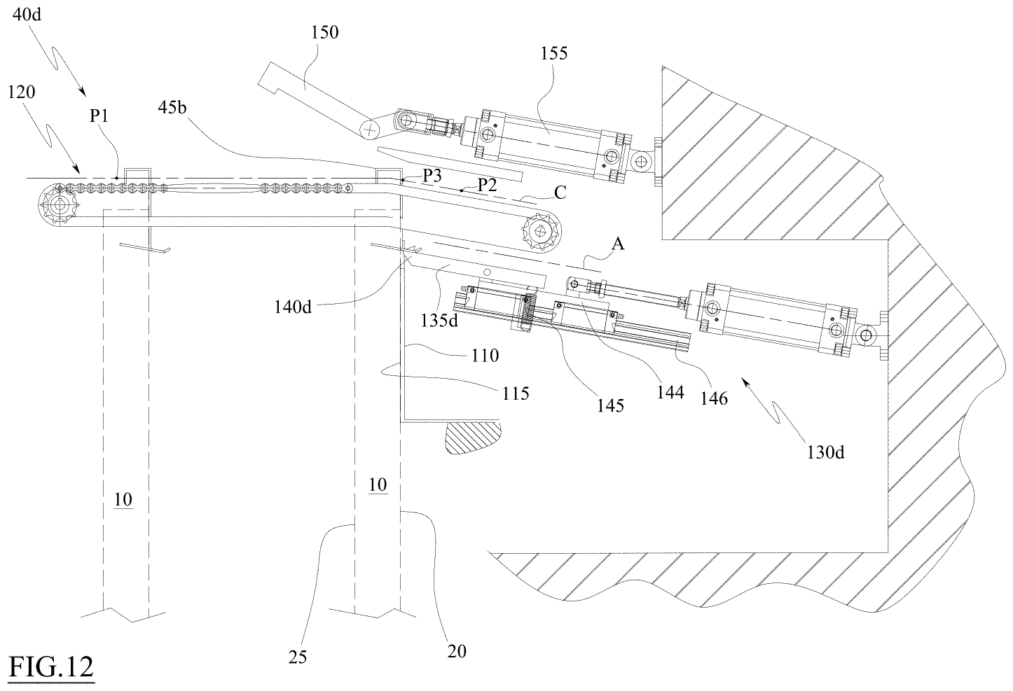

In the embodiments illustrated in FIGS. 12-15 and 19-24, on the other hand, a grasping appendage 75b,75d formed by a single body, i.e., a single appendage body, e.g., connected to the second face 70b,70d in the plurality of sections of the second face, is illustrated.

This single appendage body includes an end edge that is opposite the second face and is continuous, i.e. seamless, along the entire extension of the appendage body itself.

This single appendage body, in the embodiments illustrated in FIGS. 12-15 and 19-24, may also be seen as a plurality of appendage bodies rigidly connected directly to each other at their respective portions distal from the second face.

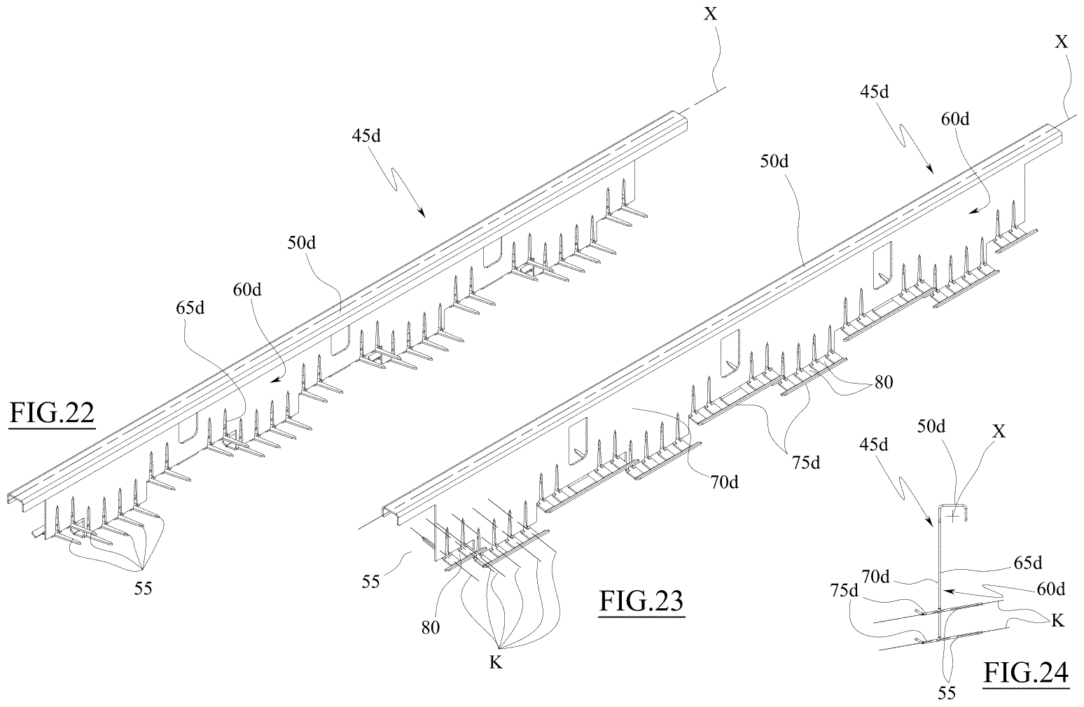

If there are then several rows of hooks arranged at different distances from the bar, the above concepts apply for each row of hooks, as illustrated in the embodiment of FIGS. 22-24. In particular, in such a case, the support element may preferably comprise for each row of hooks a respective grasping appendage, which rises from a portion of the second face proximal to said respective row of hooks and develops in a direction away from the first face and the second face itself. All the considerations made above about the possible characteristics of the grasping appendage apply to such a grasping appendage.

Furthermore, in the case of a single body, in the embodiments illustrated in FIGS. 12-15 and 19-24, there are a plurality of through slots 80, not recesses, aligned along a direction parallel to the longitudinal axis X (arranged at regular intervals).

Furthermore, in such embodiments, the hooks are derived from a space in the single body of the grasping appendage between two adjacent slots, as the support elements shown there are made by cutting and bending a single sheet of sheet metal.

All the embodiments have in common that the bar 50 has a longitudinal extension greater than the length of the row of hooks (needles) and/or the connection body along a direction parallel to the longitudinal axis X, in the case where the connection body extends longitudinally more than the row of needles.

In particular, the bars each comprise a pair of opposite longitudinal ends which project longitudinally with respect to the connection body, for example by the same amount.

The bar illustrated in the different embodiments is not necessarily the one illustrated in the precise embodiment of the support element, but may also be any of the bars of the other embodiments, at least at the longitudinal ends.

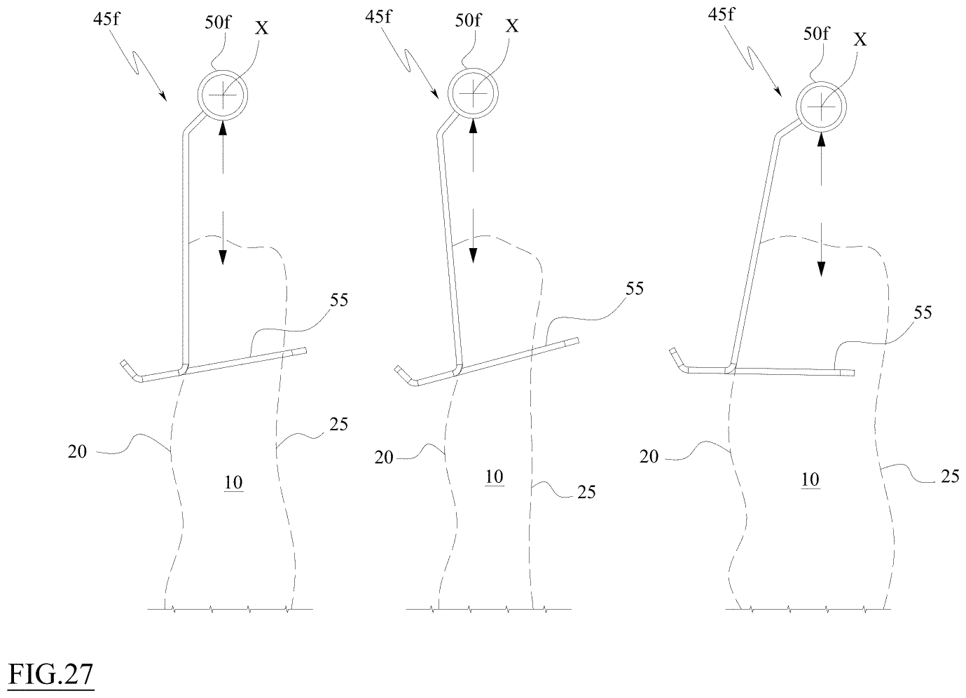

In particular, in all the embodiments illustrated, the bar may be shaped like any one of the bars illustrated in FIGS. 27-34, at least at the longitudinal ends. As will be clear below, the peculiarities of such bars are independent from the fact that the hooks are made as straight needles, and can enjoy independent protection even with respect to the precise positioning of the grasping appendage rigidly integral with the second face in at least a plurality of side-by-side sections along said longitudinal direction along which the grasping appendage develops, and in which there is at least one of said sections every two consecutive needles. The shape of the bar in the portion comprised between the longitudinal ends is of relative importance for the purposes of the present invention, whereas the shape of the longitudinal ends is more important.

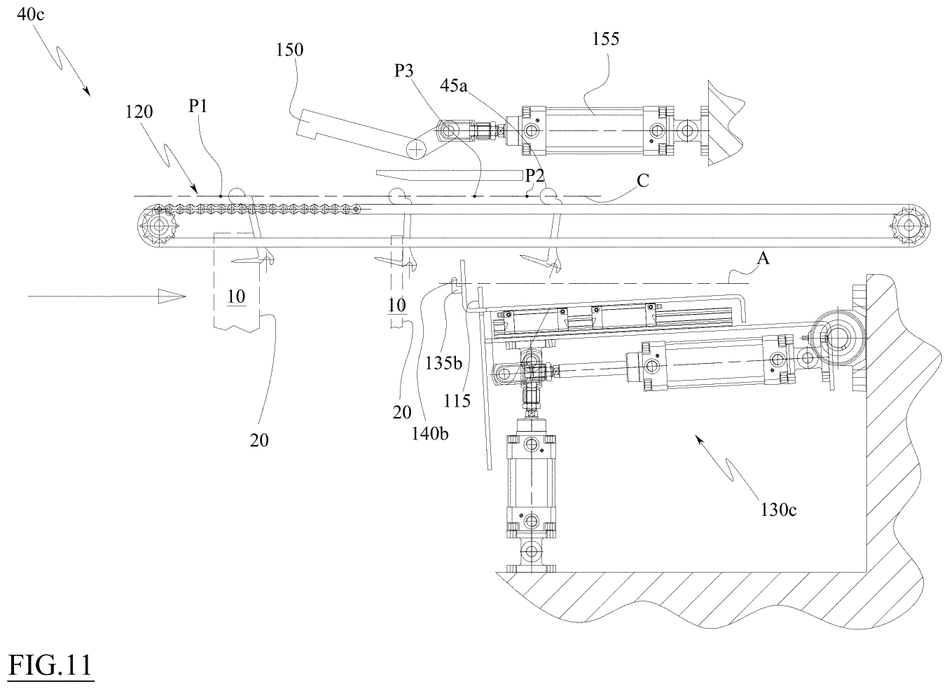

For example, the bar may have, at least at the longitudinal ends, a circular shaped cross-section (with respect to the longitudinal axis X), as in the embodiments shown in FIGS. 1-11 and 27. In particular, the longitudinal ends may be cylindrical.

Preferably, the bar may have, at least at the longitudinal ends, a flat surface 90g,90h (forming part of an outer surface of the bar, i.e., an outer surface of the longitudinal ends) lying in a plane parallel to the longitudinal axis and having a length in a direction transverse to the longitudinal axis of at least 0.6 times the length of a hook, or needle, of the plurality of hooks, measured along a longitudinal axis of the hook, or along the longitudinal axis K of the needle. In addition, the flat surface 90g,90h faces the hooks and lies in a plane parallel to the longitudinal axis X.

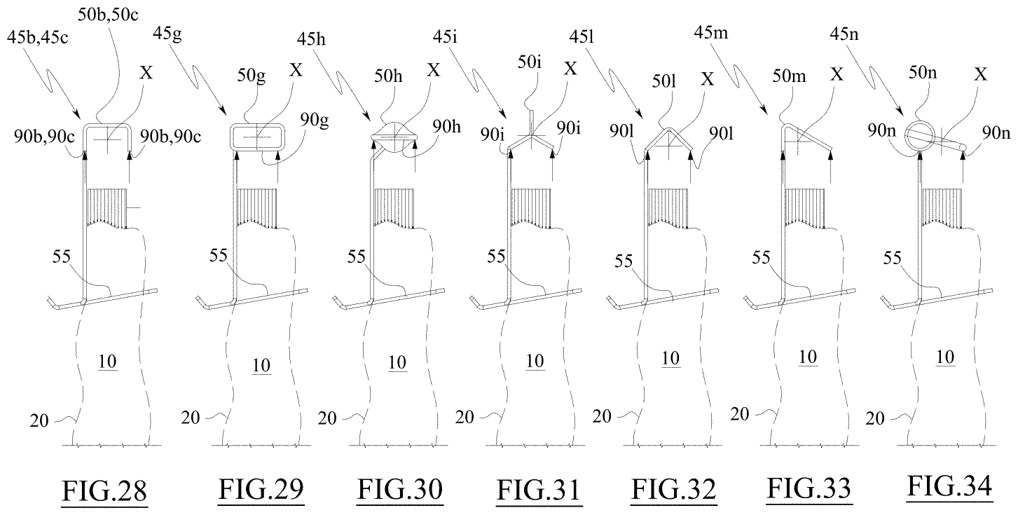

Compared to the bar with cylindrical longitudinal ends, this increases the range of thicknesses of the portions of meat in which the support element does not rotate around the bar. In particular, as can be seen by comparing FIG. 27 with FIGS. 28-34, in the case where the bar has cylindrical longitudinal ends, when the thickness of the bacon is above or below the range for which the support element is designed, the bar tends to rotate, leading to excessive inclinations of the needles and variations in the position of the portion of meat, which can create problems when used in automated plants. The bar with flat ends, on the other hand, allows this range to be extended.

Embodiments of this bar type are illustrated in FIGS. 29 and 30, where in the first the bar has a rectangular outer surface (in cross-section with respect to the longitudinal axis K) and in the second the bar is round with flat (squashed) ends.

The same advantage is obtained if the bar presents, or at least its longitudinal ends each present, a pair of flat surfaces 90b,90c, or a pair of curved surfaces 90n, extending longitudinally parallel to the longitudinal axis X and tangent to the same plane parallel to the longitudinal axis X and spaced apart in a direction transverse to the longitudinal axis X by an amount at least equal to 0.6 times the length of a hook, or needle, of the plurality of hooks (needles) measured along the longitudinal axis of the hook (needle). In addition, these flat or curved surfaces face the hooks.

Such features are present in the embodiment of the bar illustrated in FIG. 28, where the bar is a C-shaped folded plate with concavity facing the hooks and the ends of said C are flat surfaces lying in the same plane, and in the embodiment of FIG. 34, where a cylindrical bar is shown to the longitudinal ends of which a pin is attached extending in a direction transverse to the longitudinal axis X.

The advantage is also obtained in the case where the bar has, or at least its longitudinal ends each have, a pair of edges 90i,90l which develop in a direction parallel to the longitudinal axis X, lie on the same plane parallel to the longitudinal axis and are spaced apart from each other in a direction transverse to the longitudinal axis X by an amount at least equal to 0.6 times the length of a hook, or a needle, of the plurality of hooks (needles) measured along the longitudinal axis of the hook (needle). In addition, these edges face the hooks.

Bars with these characteristics are illustrated in FIGS. 31 and 32, where the bars have a cross and a V-shaped cross-section respectively and are constructed as bent and/or welded plates with two edges proximal to the hooks that lie in the same plane and are spaced along the direction transverse to the longitudinal axis.

FIG. 33 shows a solution that is hybrid to (and equivalent to) those above, in which there is an edge and a flat surface lying in the same plane.

Below is a detailed description of the exact embodiments illustrated.

FIGS. 1 to 11 and 25 to 25 illustrate two embodiments of the support element in which there is an appendage body for each hook 55, i.e. each needle, and the appendage body is aligned with the respective hook along a plane perpendicular to the longitudinal axis X, i.e. each appendage body is intersected by a plane perpendicular to the longitudinal axis X and intersecting the respective hook. Each appendage body comprises a respective recess 85, which is for example aligned with the longitudinal axis K of the respective needle, and preferably the recess is oriented with concavity facing in the opposite direction to the bar. It is not excluded that in an alternative embodiment the recesses may be replaced by slots arranged with a central axis perpendicular to a plane on which the longitudinal axis X lies, for example arranged with a central axis transverse (perpendicular) to the longitudinal axis K of the respective needle.

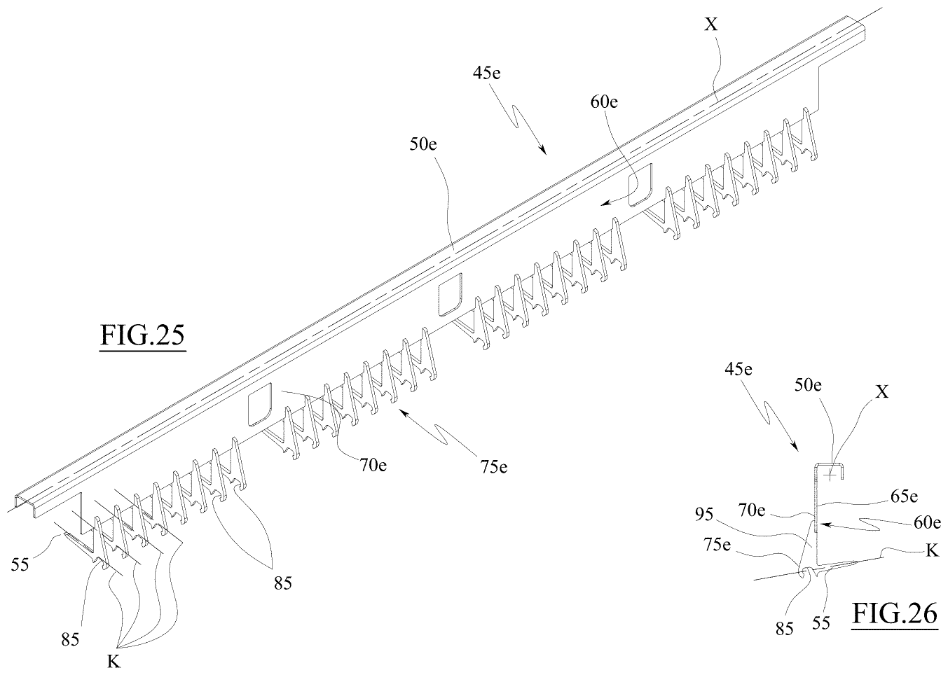

Also in such embodiments, the connection body 75a,75e, or a portion of the connection body distal from the bar, is made as a plurality of bodies rigidly attached independently from each other to the bar, or to a portion of the connection body proximal to the bar. Further, in the embodiment of FIGS. 25 and 26, the support element includes a stiffening flange 95 that rigidly connects a portion of the grasping appendage 75e distal from the second face 70e to a central portion of the second face, interposed between a portion of the second face proximal to the bar and a portion of the second face proximal to the hooks.

Additionally, in this embodiment, the connection body, hooks and grasping bodies of the grasping appendage (e.g. also the stiffening flange) are made as a single body. It is not excluded that in an alternative embodiment, even just a needle and the respective grasping body can be made into a single body attached to the connection body.

In the embodiment of FIGS. 1 to 1, the bar 50a is cylindrical in shape and in the embodiment of FIGS. 25 and 26, the bar 50e is made by bending a sheet of metal and has the characteristics mentioned above for C-shaped bars.

FIGS. 16-18 illustrate a support element characterized in that it comprises a grasping appendage 75c made as a seamless flat rectilinear plate (i.e. without recesses or slots) that, for example, extends longitudinally along the entire extension measured along the longitudinal axis X of the connection body 70c. The plate is a body with a reduced thickness which has its smallest dimension in a direction perpendicular to the distancing direction of the grasping appendage itself.

Furthermore, in this embodiment the hooks 55 are shaped like needles and the flat rectilinear plate is intersected, e.g. also divided into two symmetrical parts, by the laying plane of the longitudinal axes K along its entire extension in the distancing direction. As mentioned above, this type of grasping appendage must be grasped with a clamp mechanism (not shown) that clamps the plate in a vice-like manner in a direction perpendicular to the direction of departure.

Additionally, the bar is made by bending a sheet of metal and has the characteristics mentioned above for C-shaped bars.

Preferably the entire support element is made by bending and cutting a single sheet of metal.

In the embodiment illustrated in FIGS. 12-15 and 19-21, the support element 45b is characterized in that it comprises a grasping appendage 75b made as a single body extending in a longitudinal direction along the entire length of the row of needles or of the connection body, and for example in the form of a flat plate at least in a portion of the grasping appendage proximal to the second face, and which is provided with a plurality of through slots 80.

There is at least one such through slot 80 for each hook 55.

Preferably, two slots are provided for each hook 55, or at least for most hooks, which slots are located laterally with respect to the hook, i.e. with respect to an imaginary projection of the hook onto the grasping appendage, said imaginary projection being made along a longitudinal axis of the hook itself. In the exact embodiment, the hooks are needles and the through slots 80 are eccentric to the longitudinal axis K of the respective needle. In practice the slots do not intersect the longitudinal axis K and preferably are not intersecting and are placed immediately to the side of a projection of the needle on the grasping appendage, i.e. on the flat plate, said projection being made along the longitudinal axis K of the needle.

For example, two adjacent hooks have a common slot.

The plate is a body with a reduced thickness which has its smallest dimension in a direction perpendicular to the distancing direction of the grasping appendage itself.

At least the portion of the grasping appendage proximal to the second face, which is made as a flat plate parallel to the longitudinal axis X, is intersected, for example even divided into two symmetrical parts, by the laying plane of the longitudinal axes K throughout its extension in the distancing direction.

The grasping appendage also comprises a portion distal from the second face, placed at a greater distance from the second face than the through slots, which is made as a flat plate inclined with respect to the flat plate of the portion proximal to the second face and parallel to the longitudinal axis X. This is to allow even more stable grasping.

Additionally, the bar is made by bending a sheet of metal and has the characteristics mentioned above for C-shaped bars.

Preferably the entire support element is made by bending and cutting a single sheet of metal.

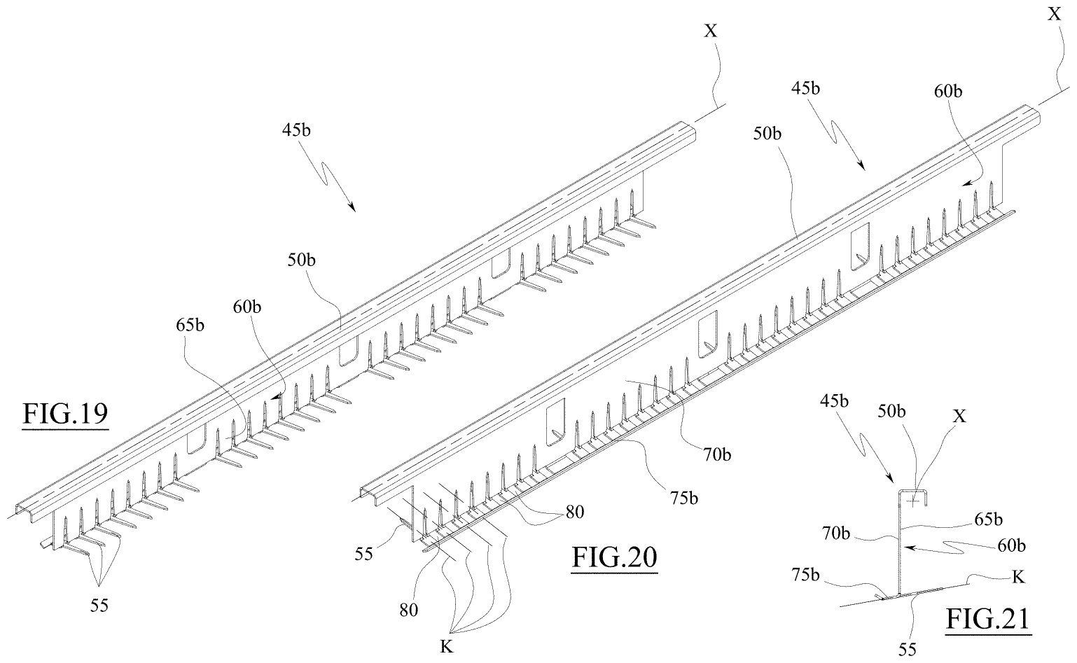

FIGS. 22-24 illustrate a embodiment of the support element which differs from the embodiment illustrated in FIGS. 19-21 solely in that the hooks 55, for example shaped like needles, are divided into at least two rows which are at different distances from the bar 50d and for each of said rows there is a respective grasping appendage 75d. This plurality of grasping appendages is therefore placed at different distances from the bar.

The different bars of the support elements are interchangeable with each other, although embodiments in which the bar (at least at its longitudinal ends) is not a single cylindrical body are preferable.

The support elements 45 with a grasping appendage 75 may be used in a processing sequence in which the portion of meat 10 is manually removed from the support element, i.e., the support element is removed from the portion of meat, manually, by an operator acting by hand by gripping the grasping appendage or by grasping it using a suitable tool (e.g., a gripper or a tool having a plurality of hooks adapted to be inserted into the through slots/recesses). However, it is preferable to use an automated unloading apparatus such as the one described below.

When a portion of meat 10 is hooked to a respective support element 45, it means that the hooks 55, i.e. the needles, (all of them, unless there is a positioning error or excessive unevenness of the portion of meat) are inserted into the portion of meat 10 and pass through at least the first greater face 20 of the portion of meat, preferably passing through it from the first greater face 20 to the second greater face 25. In the following, the first greater face will be taken as the one which is definitely pierced by the hooks and which is proximal to the connection body 60. In particular, at least a portion of the first greater face 60 directly contacts the first face 65 of the connection body.

The portion of meat is attached/associated/hooked to the hooks 55 in an end portion thereof (peripheral portion), e.g. longitudinal, and under normal handling conditions hangs vertically from the hooks with most of its extension being below the support element 45 to which they are hooked (as illustrated in all the figures). In addition, the portions of meat 10, after the envisaged processing stations (smoking and/or cooling/freezing) are rigid in the sense that they have a shape of their own and are not easily deformed as when the meat is unprocessed.

The invention makes available a method for extracting the portions of meat 10 from the respective support elements 45 to which the portion of meat is hooked.

The method comprises first of all making available such a support element 45 to which at least one portion of meat is hooked and having at least the following characteristics:
the plurality of hooks 55 by means of which the portion of meat is hooked to the support element itself,
the bar 50 to which said hooks are rigidly connected by means of the connection body 60 comprising the first face 65, from which said hooks rise, and the second face 80 facing in the opposite direction to the first, and
the grasping appendage 75 rising from the second face 70 in at least one direction away from the first face and the second face itself.

Provided that this is the case, the method comprises the steps of (only) pulling the grasping appendage 75 (only) in a predetermined extraction direction A while:
either the portion of meat 10 is held (in a predetermined position) e.g. by acting on its first greater face of the hooked portion of meat,
or the portion of meat 10 is pushed, preferably by acting on it (only) with a thrust force on the first face 20 of the portion of meat (no other force acting anywhere else on the portion of meat), (only) in a predetermined thrust direction B opposite (and parallel to) the predetermined extraction direction A in which the grasping appendage 75 is pulled,
   in both cases completely removing the hooks from the portion of meat. That is, these steps (of pulling the grasping appendage while holding the portion of meat or pulling the grasping appendage while pushing the portion of meat in the opposite direction) are performed until the hooks are completely (all) removed from the portion of meat.

This method allows the portions of meat 10 to be detached from the support elements 45 more efficiently than known methods of the prior art, as it does not suffer from errors in positioning the bacon on the support element, which may lead to excessive overlapping of the portion of meat with the first face, since the extraction of the hooks from the portion of meat is not performed by pushing on the first face to move it away from the portion of meat, but rather by pulling the support element at the second face, so as to move the first face away from the portion of meat.

The predetermined extraction direction A is, for example, straight.

The step of pulling the grasping appendage 75 in a predetermined extraction direction A is preferably performed by means of an automated gripping unit 130, therefore the method may comprise the step of arranging an automated gripping unit 130 configured to grasp and pull the grasping appendage 75 in the predetermined extraction direction A when the grasping appendage is in a predetermined position.

The step of pushing the portion of meat in the opposite direction to the extraction direction is preferably performed by means of an automated thrust unit, therefore the method may comprise the step of arranging an automated thrust unit configured to push the portion of meat in the predetermined pushing direction when the grasping appendage is grasped and pulled by the gripping unit.

In embodiments of an unloading apparatus implementing the steps of the method described herein and illustrated in Figures xx, the method comprises the steps of pulling (only) the grasping appendage 75 in a predetermined extraction direction while retaining (in a predetermined position) the portion of meat 10. However, it is clear to a person skilled in the art how to modify the gripping unit 130 to add the thrust unit 205 and obtain an unloading apparatus that implements the method of pulling the grasping appendage while pushing the portion of meat in the opposite direction.

The method may provide that the step of pulling the grasping appendage 75 in the extraction direction is preceded by the steps of:
preparing a striker body 110 defining a striker surface 115, e.g. flat,
bringing a section of one face of the portion of meat contacting the first face of the connection element, i.e. the first greater face 20 of the portion of meat 10, into contact with the striker surface 110 by acting on the bar and/or on the grasping appendage.

In all of the illustrated embodiments of the apparatus implementing the method, the method provides that the positioning of the first greater face of the portion of meat in contact with the striker surface is performed by acting directly, i.e., by applying forces directly, on both the bar and the grasping appendage, or only on both the bar and the grasping appendage. In practice, no action is taken on the connection body and in particular no force is applied directly to the first face of the connection body. However, it cannot be ruled out that it may be sufficient to act on the bar alone to bring the first greater face into contact with the striker surface 115.

In the presence of the striker surface, the predetermined extraction direction A in which the grasping appendage is pulled is away from the striker surface 115.

Furthermore, the step of retaining the portion of meat comprises the step of keeping the striker surface 115 fixed with respect to the support element 45, for example fixed at a predetermined position in space, while performing the step of pulling the grasping appendage 75 in the predetermined extraction direction A, so as to extract the hooks from the portion of meat which is prevented from moving integrally with the support element thanks to the striker surface.

The step of pushing the portion of meat (acting on its first greater face) in an opposite direction to the predetermined extraction direction while pulling the grasping appendage, comprises the step of moving the striker surface in an opposite direction to the extraction direction while performing the step of pulling the grasping appendage in the predetermined extraction direction, so as to extract the hooks from the portion of meat which is prevented from moving integral with the support element by the striker surface. As mentioned above, this last embodiment is not illustrated in the figures, but it is a combination of the embodiments of the apparatus of figures xx, in which the striker surface is fixed, with the embodiment of figures xx, in which, as will be explained below, the striker surface is movable and the gripping unit merely holds without pulling the grasping appendage, within the reach of a person skilled in the art.

When the striker body is present, the automated gripping unit 130 is preferably configured to grip and pull the grasping appendage in the predetermined extraction direction A when the grasping appendage is at a predetermined distance from the striker surface 115. In particular, this predetermined distance is before the portion of meat being handled touches the first face of the striker surface.

The method may further provide that the step of bringing a section of the first greater face 20 of the portion of meat into contact with the striker surface by acting on the bar and/or on the grasping appendage is performed by means of an automated handling unit 120 configured to move the support element by acting on the bar and/or by means of an automated gripping unit 130 configured to grasp and pull the grasping appendage.

In the embodiments illustrated in the figures, it is envisaged that this step will take place by means of both the handling unit and the gripping unit.

The step of pulling the grasping appendage to extract the needles from the portion of meat then begins after the first greater face is in contact with the striker surface.

Preferably, it is envisaged that the grasping appendage is grasped by the gripping unit 130, before the first greater face of the portion of meat comes (is brought) into contact with the striker surface.

The method may envisage that the step of bringing a section of the first greater face of the portion of meat into contact with the striker surface by acting on the bar and/or on the grasping appendage is preceded by the step of moving, for example by means of the automated handling unit the support element 45, by acting (only) on its bar 50, in a predetermined movement direction along a predetermined trajectory C (open, i.e. not closed in a loop) transverse to a laying plane of the striker surface and placed at a predetermined distance from the striker surface, so that the portion of meat moved along this trajectory reaches a section thereof (central) for contacting the striker surface with its face in contact with the first face of the connection element. In particular, the trajectory comprises a first point P1, upstream of the striker surface 115 with respect to the predetermined movement direction, and a second point P2 downstream of the striker surface with respect to the movement direction. The trajectory also includes a third point P3, which corresponds to the point where the first greater face of the portion of meat is in contact with the striker surface. That is, when the bar of the connection element reaches the third point, the first greater face of the portion of meat is in contact with the striker surface 115.

The handling unit is configured to move the support element along this trajectory C in the predetermined direction, at least from the first to the second point.

In addition, during movement along said trajectory, the second face 70 of the connection element 60 is kept facing the second point, i.e. it is kept facing a plane parallel to the laying plane of the striker surface 115 and intersecting the second point P2. In other words, the handling unit is configured to move the support element along this trajectory while keeping the second face of the support element facing a plane parallel to the laying plane of the striker surface and intersecting the second point.

The predefined trajectory lies in a plane perpendicular to the laying plane and the longitudinal axis X of the bar of the support element moved.

The predefined trajectory is, for example, straight or made up of several consecutive straight sections.

In addition, the predetermined direction in which the grasping appendage is pulled is, for example, in the direction of approach to the second point of the trajectory, i.e. in the direction of approach to the plane parallel to the plane of the striker surface and intersecting the second point.

In the case where the support elements comprise hooks in the form of needles, as in the illustrated figures, the method may provide that the extraction direction A is parallel to the longitudinal axes K, preferably that it is also aligned therewith, or that it lies in a plane in which the longitudinal axes K lie. In this circumstance, reference is made to the longitudinal axes as they are arranged while the support elements are moved from the first point towards the second point, and in detail as they are devices in proximity to the striker surface, for example at the third point P3.

In particular, the extraction direction is parallel to the longitudinal axes K, preferably also aligned with them, at the moment when the grasping appendage is grasped. This specification is particularly important in cases where the bar 50 has cylindrical longitudinal ends and can therefore rotate more easily as the thickness of the portion of meat changes.

In addition, where the grasping appendage includes recesses or through slots, the gripping unit includes a gripping body configured to grip all the through slots or recesses in the grasping appendage.

The striker surface may lie on a vertical or horizontal plane.

In the case where the striker surface lies in a vertical plane, the predetermined extraction direction is substantially horizontal, whereas in the case where the striker surface lies in a horizontal plane, the predetermined extraction direction is substantially vertical.

The invention also makes available another method that solves the same technical problem of the prior art as the method described above.

This other method, or second method to differentiate it from the first method described above, involves first making available such a support element 45 to which at least one portion of meat is attached and having at least the following characteristics:
the plurality of hooks 55 by means of which the portion of meat is hooked to the support element itself,
the bar 50 to which said hooks are rigidly connected by means of the connection body 60 comprising the first face 65, from which said hooks rise, and the second face 80 facing in the opposite direction to the first, and
the grasping appendage 75 rising from the second face 70 in at least one direction away from the first face and the second face itself.

Provided that this is the case, the second method comprises the steps of (only) retaining the grasping appendage (in a predetermined position) while pushing the portion of meat 10, for example by acting on its first greater face 20 of the attached portion of meat, preferably by acting only with a thrust force on the first face of the portion of meat (no other force acting anywhere else on the portion of meat), (only) in a predetermined thrust direction B away from the hooks 55 of the support element, (e.g. also from the first face 65 and from the grasping appendage 75), completely pulling the hooks out of the portion of meat, i.e. such steps are performed until the hooks are completely (all) pulled out of the portion of meat. This distancing direction, for example, faces the same direction which the first face of the support element faces.

The step of retaining the grasping appendage in a predetermined direction is preferably performed by means of an automated gripping unit 130, so the method may provide for the step of arranging an automated gripping unit 130 configured to grasp and retain the grasping appendage in a predetermined position when the grasping appendage is in a predetermined position.

The step of pushing the portion of meat in the predetermined thrust direction B is preferably performed by means of an automated thrust unit 205, therefore the method may provide for the step of arranging an automated thrust unit 205 configured to push the portion of meat in the predetermined distancing direction when the grasping appendage is held by the gripping unit.

The method can provide that the step of pushing the portion of meat in the predetermined distancing direction is preceded by the steps of:
preparing a striker body 110 defining a striker surface 115, e.g. flat,
bringing a section of one face of the portion of meat contacting the first face of the connection element, i.e. the first greater face 20 of the portion of meat, into contact with the striker surface 155 by acting on the bar 50 and/or on the grasping appendage 75 of the support element.

The striker surface may lie on a vertical plane or on a horizontal plane; only the version with a vertical striker surface is shown in the figures of the apparatus implementing this method.

In the illustrated embodiment of the unloading apparatus implementing the method, the positioning of the first greater face of the portion of meat in contact with the striker surface can take place by acting directly, i.e. applying forces directly, only on the bar. In practice, no action is taken on the connection body or the grasping appendage to carry out this step.

In the presence of the striker surface 115, the pushing of the portion of meat is performed by moving the striker surface 155 in the predetermined thrust direction B.

Furthermore, the step of retaining the grasping appendage 75 comprises the step of keeping said grasping appendage fixed in a predetermined position in space while performing the step of pushing the portion of meat 10, for example by moving striker surface, in the predetermined thrust direction B, so as to extract the portion of meat from the hooks, which are prevented from moving integrally with the portion of meat because the grasping appendage 75 is kept in the predetermined position.

When the striker body is present, the automated thrust unit 205 may be configured to push the portion of meat in the predetermined thrust direction B when the grasping appendage 75 is at a predetermined distance from the striker surface. In particular, this predetermined distance is before the portion of meat being handled touches the first face of the striker surface.

Alternatively, the step of moving the striker surface in the thrust direction B to extract the hooks 55 from the portion of meat may begin after the first greater face is in contact with the striker surface.

In any case, the striker surface is moved to extract the portion of meat only after the grasping appendage has been grasped.

It may be provided that the grasping appendage is grasped by the gripping unit, before the first greater face of the portion of meat comes (is brought) into contact with the striker surface.

The method may further provide that the step of bringing a section of the first greater face 20 of the portion of meat into contact with the striker surface 115 by acting on the bar and 50 is performed by means of an automated handling unit 120 configured to move the support element by acting on the bar and/or by means of the automated gripping unit 130 configured to grasp and pull the grasping appendage.

The method may comprise that the step of bringing a section of the first greater face of the portion of meat into contact with the striker surface by acting on the bar and/or on the grasping appendage is preceded by the step of moving, for example by means of the automated handling unit 120, the support element 45, by acting (only) on its bar 50, in a predetermined movement direction along a predefined trajectory C, the characteristics of which will not be repeated, since they are the same as the predefined trajectory C of the first method.

The predetermined thrust direction in which the portion of meat is pushed is for example in the direction of approach to the first point of the trajectory, i.e. in the direction of approach to a plane parallel to the laying plane of the striker surface and intersecting the first point.

In the case where the support elements comprise hooks 55 in the form of needles, as in the illustrated figures, the method may provide that the predetermined thrust direction is parallel to the longitudinal axes K, preferably also aligned with them, or that it lies on a plane on which the longitudinal axes K lie.

In this circumstance, reference is made to the longitudinal axes as they are arranged as the support elements are moved from the first point towards the second point, and in detail as they are devices in proximity to the striker surface, for example at the third point P3.

In particular, the thrust direction is parallel to the longitudinal axes K, preferably also aligned with them, at the moment when the grasping appendage is grasped.

In the embodiment illustrated, this thrust direction is inclined with respect to a vertical plane.

In addition, where the grasping appendage includes recesses or through slots, the gripping unit includes a gripping body 135 configured to grip all the through slots or recesses in the grasping appendage.

As mentioned above, such methods are implemented in automated unloading apparatuses 40 configured to release/remove one or more portions of meat from a respective support element to which they are attached.

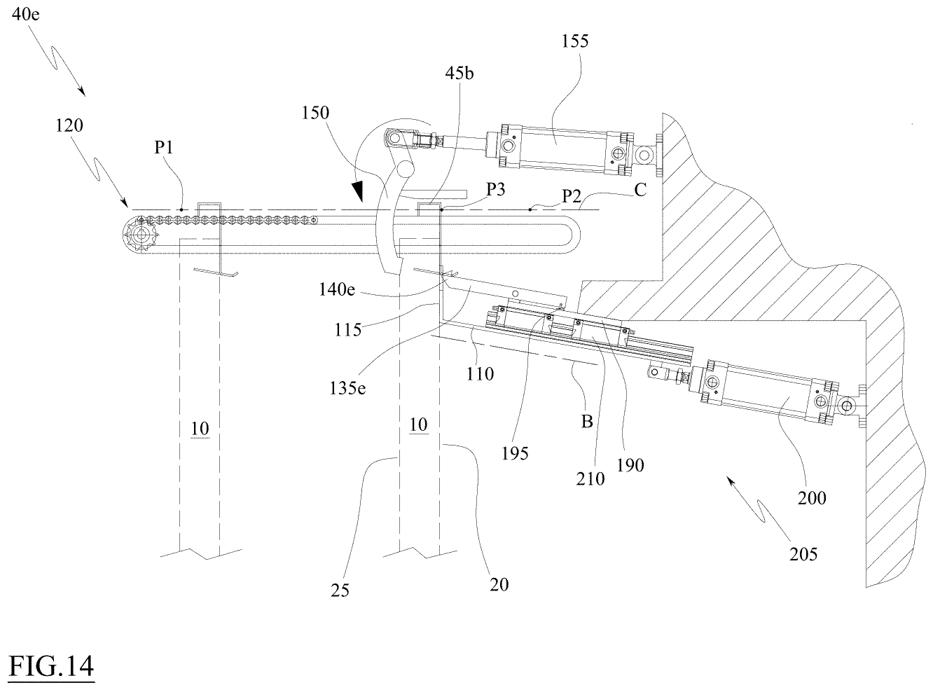

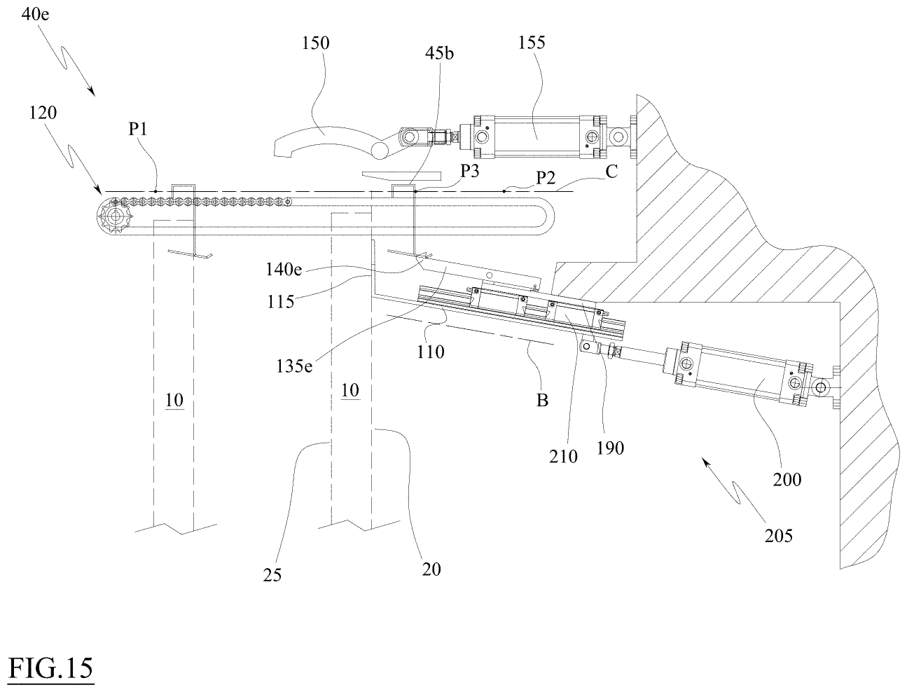

Respectively, the first method is implemented by the unloading apparatus 40a,40b,40c,40d of FIGS. 1-13 and the second method by the unloading apparatus 40e of FIGS. 14-15.

The apparatuses implementing the first method will be described first below.

In all the unloading apparatus there is a striker body 110, which is capable of contacting, i.e. being contacted by the portion of meat 10, for example by the first greater face 20 of the portion of meat. In particular, the striker body 110 comprises a striker surface 115 adapted to be contacted by the portion of meat 10, in particular by the first greater face 20 of the portion of meat.

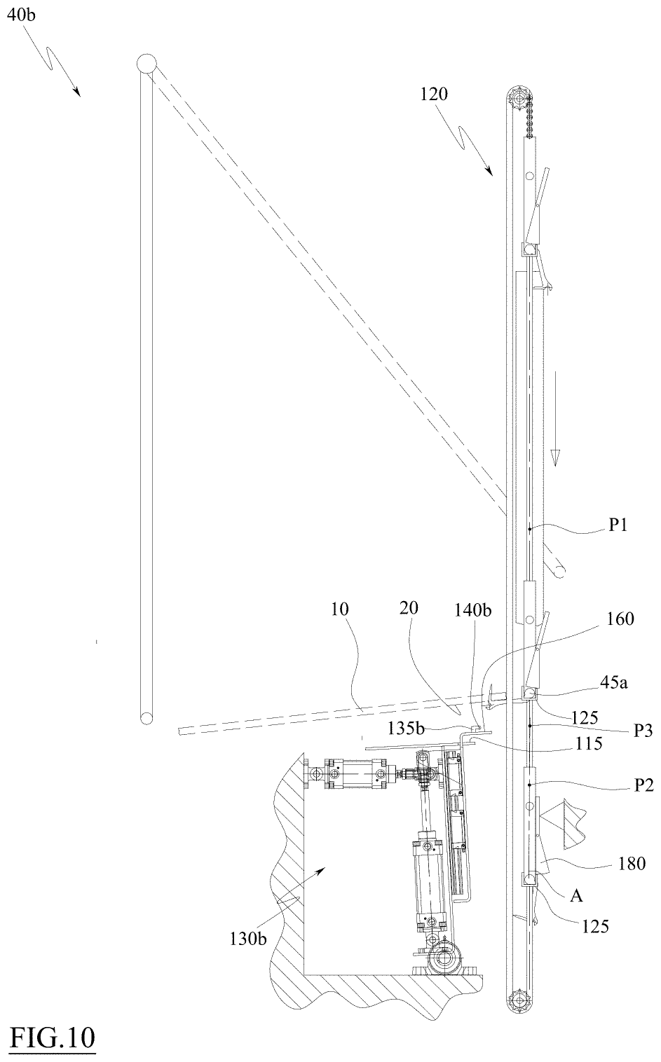

In the embodiments illustrated, the striker surface 115 is flat, and may lie either on a vertical plane, as in FIGS. 1-9 and 11-13, or on a horizontal plane, as in FIG. 10.

In the case where the grasping appendage is provided with a plurality of grasping bodies as in embodiments 75a and 75e, the striker surface 115 comprises a plurality of protuberances that develop along the laying plane of the striker surface 115 itself starting from an edge thereof and are configured and sized to fit into the gaps present between the grasping bodies.

In the case of the embodiments of the unloading apparatus 40a,40b,40c,40d implementing the first method, the striker body 110 is fixed with respect to the support element 45, or rather is at least fixed with respect to a gripping body, as will be described below. In particular, in the embodiments of the unloading apparatus 40a and 40d the striker body 110 is rigidly fixed to a frame of the support apparatus. While in the embodiments 40b and 40c, the striker body 110 is hinged to the frame of the support apparatus and the gripping body is movable with respect to the striker body, for example it is associated with the striker body by a straight slide.

In all embodiments of the apparatus 40a,40b,40c,40d, the unloading apparatus further comprises a handling unit 120 of the support elements, which is of an automated type and is configured to move the at least one support element in a predetermined direction along a predefined trajectory C. In particular, the bar of the support element is moved along a trajectory that is perpendicular to the longitudinal axis X of the bar itself.

During movement along this predefined trajectory C, the support element is kept with its longitudinal axis X lying on a horizontal plane and is moved perpendicular to its longitudinal axis X.

Said predefined trajectory is transverse, preferably perpendicular, to a laying plane of the striker surface and is placed at a predetermined distance from the striker surface 115 such that the portion of meat with which the support element is associated and moved along such trajectory comes into contact with the striker surface. This trajectory is therefore eccentric to the striker surface. Furthermore, the distance is preferably such that at least a portion of the first face greater than 20 of the portion of meat protruding from the support element and proximal to the hooks of the support element comes into contact with the striker surface.

The predefined trajectory lies in a plane perpendicular to the laying plane and the longitudinal axis X of the bar of the support element moved.

In addition, the trajectory is preferably oriented in such a way that at a (single) point in the trajectory the longitudinal axis X of the support element lies (entirely) in the laying plane of the striker surface.

Therefore, if the striker body lies on a vertical plane, the predefined trajectory lies on a vertical plane that is transverse, e.g. perpendicular, to the laying plane of the striker surface lies and develops horizontally.

If the striker body lies on a horizontal plane, the predefined trajectory lies on a vertical plane transverse, e.g. perpendicular, to the laying plane of the striker surface and develops essentially vertically.

The predefined trajectory is, for example, straight or formed by a number of consecutive straight lines lying on the same vertical plane.

The trajectory comprises a first point P1, upstream of the striker surface with respect to the predetermined movement direction, and a second point P2 downstream of the striker surface with respect to the movement direction.

Thus, if the striker body lies in a vertical plane, the first point is in front of the striker surface 115, i.e. the striker surface faces the first point (or faces a plane passing through the first point and parallel to the laying plane of the striker surface), and the second point is behind the striker surface 115, i.e. the striker surface faces in the opposite direction to the second point (or faces in the opposite direction to a plane passing through the second point and parallel to the laying plane of the striker surface).

The second point, i.e. the plane passing through the second point and parallel to the striker surface, is at a minimum distance from the laying plane of the striker surface greater than the length of the hooks, preferably greater than the maximum dimension of the support element measured in a direction perpendicular to the striker surface.

When the striker body instead lies on a horizontal plane, the first point is at a greater vertical height than a vertical height of the laying plane of the striker surface, and the second point is at a lower vertical height than a vertical height of the laying plane of the striker surface.

In addition, during movement along said trajectory, the second face 70 of the connection element is kept facing the second point P2, i.e. it is kept facing a plane parallel to the laying plane of the striker surface and intersecting the second point. In other words, the handling unit is configured to move the support element along this trajectory while keeping the second face 70 of the support element facing a plane parallel to the laying plane of the striker surface and intersecting the second point.

The trajectory also includes a third point P3, which corresponds to the point where the first greater face of the portion of meat is in contact with the striker surface. That is, when the bar of the connection element reaches the third point, the first greater face of the portion of meat is in contact with the striker surface.

The handling unit is configured to move the support element along this trajectory C in the predetermined direction, at least from the first to the second point.

The handling unit can be configured to handle the support element, now without the portion of meat hooked, even beyond the second point to deliver it to an apparatus configured to re-introduce the support elements freed from the portions of meat into the plant cycle.

The handling unit may comprise, for example, two inextensible flexible members each closed in a loop around two or more pulleys or toothed wheels. These flexible elements lie in vertical planes parallel to each other and are configured so that each has a flat transport surface on which the bar of the support element rests, i.e. each transport surface has a respective longitudinal end of the bar.

The transport surface, or the transport surfaces, lie on a substantially horizontal (+/−20°) plane, preferably horizontal.

In the case where the striker surface lies in a vertical plane, along the entire trajectory C from the first to the second point, the flexible members themselves define, or an upper portion thereof, one or more substantially horizontal support surfaces.

In the case where the striker surface lies in a horizontal plane, a support element 125 comprising a U-shaped body with a back wall on which a respective longitudinal end of the bar rests at the top and which is defined as the flat transport surface of the bar is connected to each flexible member.

For example, the flexible member, i.e. each flexible member, is a chain (of the Galle type, i.e. for example with perforated rollers). However, in an embodiment not illustrated herein the flexible member may be a belt or a cable.

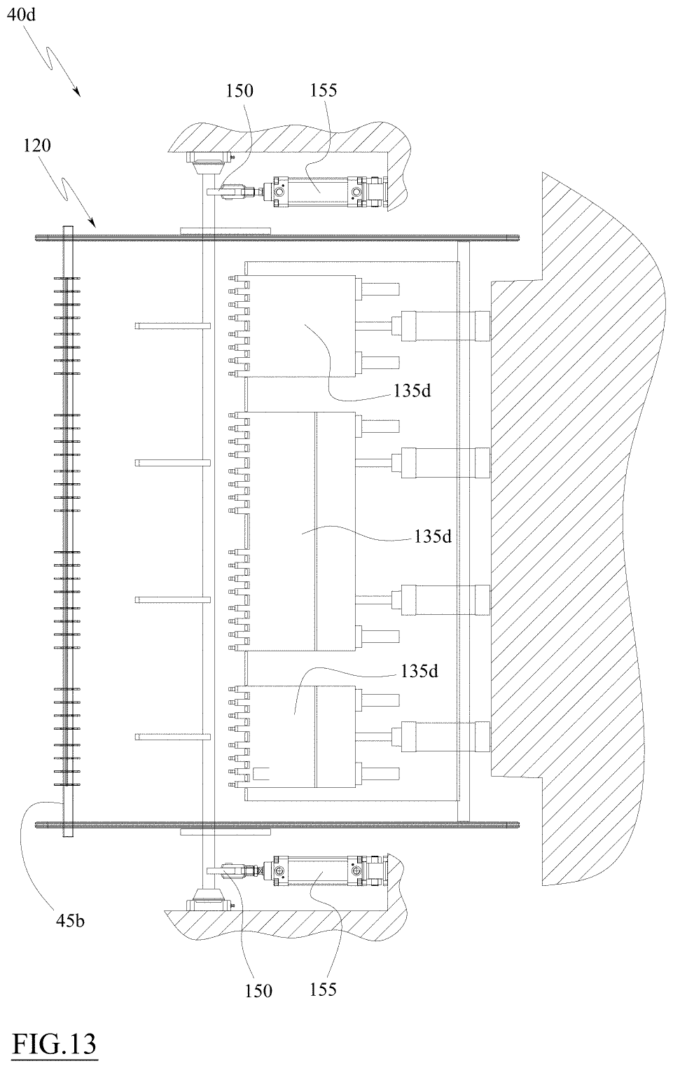

The unloading apparatus comprises a (single) gripping unit 130a,130b,130c,130d positioned in proximity to the striker surface and provided with a (single) gripping body 135a,135b,135d configured to (only) grasp the grasping appendage. As can be seen in the top view in FIG. 13, there may be a plurality of gripping bodies independent from each other (i.e. operated with independent drives) and configured to grasp a single support element. Although this possibility is only illustrated for the embodiment 40d of the unloading apparatus, it is applicable to all other forms of unloading apparatus illustrated (even those implementing the second method, in which case a plurality of striker bodies will be present).

For example, the gripping body is placed between the third point P3 and the second point P2, i.e. between planes parallel to the laying plane of the striker surface 115 and passing through these points.

The gripping unit includes a drive of the gripping body 135a,135b,135d configured to move (cyclically or selectively), the gripping body into a grasping position, wherein the gripping body grasps the grasping portion, and to subsequently pull the gripping body in a predetermined extraction direction A that is away from the striker surface 115 (and towards the second point P2, i.e., a plane parallel to the striker surface and intersecting the trajectory at the second point), extracting the hooks from the portion of meat that is retained in contact with the striker surface. The extraction direction is therefore in the same direction in which the support element is moved from the first to the second point.

In particular, the drive is configured to move the gripping body between a first position, wherein the gripping body is proximal to the striker surface and can grasp the grasping appendage, and a second position wherein it is distal from the striker surface, and wherein from the first position to the second position the gripping body is moved along the extraction direction A, towards the second point. In particular, the gripping body of the embodiment is also operable in a third position that follows the second and precedes the first, which can be defined as the disengagement position, in which the gripping body does not act on the grasping appendage (unless the gripping body is equipped with a striking body, as will become clearer below). In addition, the grasping occurs in the movement from the third position to the first position.

The handling unit and the gripping unit are synchronised in such a way that when, during the movement from the first point to the second point, the support element is at a predetermined distance from the third point (distance which can be zero or greater than zero), the drive moves the gripping body to the first position and then from the first position to the second position.

In the gripping unit 130a, the actuation of the gripping body comprises a first and a second linear actuator which are both provided with a portion connected to the frame of the apparatus itself and a portion movable with respect to the fixed portion along a rectilinear axis of movement lying on a vertical plane.

In particular, the fixed portion of the first actuator is integral without residual degrees of freedom to the frame, and the fixed portion of the second actuator is hinged to the frame according to a horizontal hinge axis.

The movable portions are hinged to the gripping body 135a according to horizontal hinge axes and eccentric to each other (the gripping body is connected only to such actuators). In addition, the movement axis of the first linear actuator is vertical, and the actuation axis of the second linear actuator is transverse to the movement axis of the first actuator.

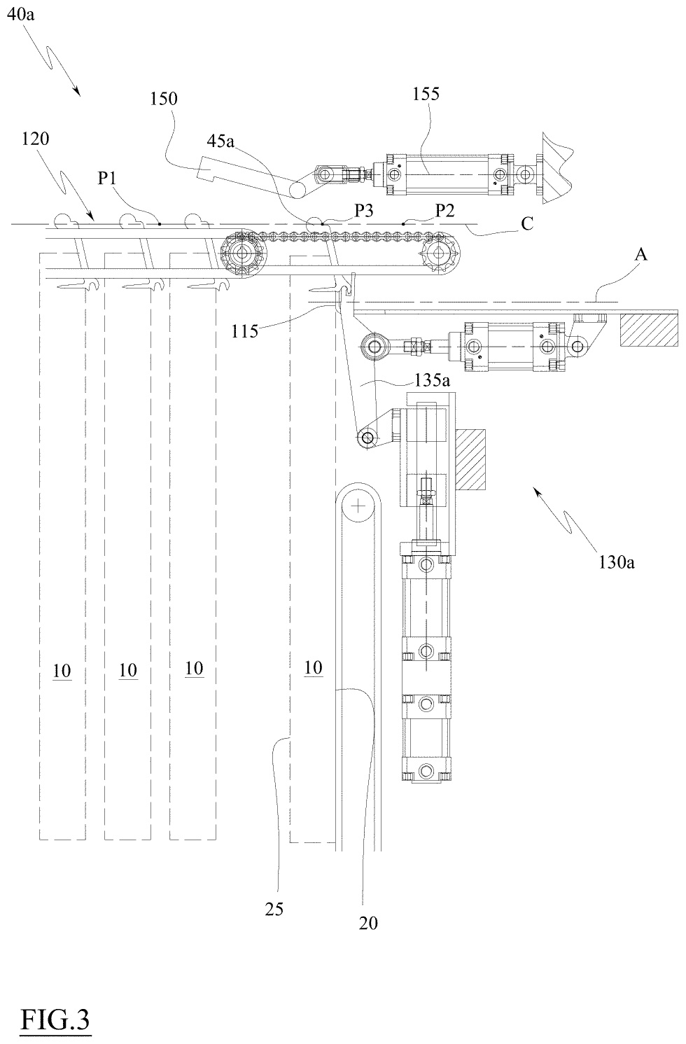

By means of the first actuator, it is possible to move the gripping body vertically to the first position (see FIG. 3), then by activating the second actuator the gripping body moves between the first position and the second position along the extraction direction A. In practice, by moving the gripping body vertically with the first actuator, it is possible to orientate the actuation axis of the second actuator so as to make it parallel or coincident with the extraction direction A. In other words again, when the movable portion of the second actuator and the movable portion of the second actuator are at a predetermined distance from the fixed portion such that the first position is realised, the actuation axis of the second actuator is found to be parallel or coincident with the extraction direction A (e.g. parallel) and the movable portion of the second actuator is moved towards the fixed portion, while maintaining the movable portion of the second actuator at the distance previously reached by its fixed portion at the first position of the gripping body, in order to move between the first position and the second position along the extraction direction A. In this way, the support element is recalibrated with respect to the striker body, which remains fixed with respect to the support element. All the hinge axes described for this embodiment of the gripper unit lie on a plane perpendicular to the predetermined extraction direction A.

In the gripping unit 130b, where the striker surface 115 is horizontal, the actuation of the gripping body comprises a first and a second linear actuator which are both provided with a portion connected to the frame of the apparatus itself and a portion movable with respect to the fixed portion along a rectilinear movement axis lying on a vertical plane.

In particular, the fixed portion of the first actuator is hinged to the frame according to a horizontal hinge axis, and the fixed portion of the second actuator is hinged to the frame according to a horizontal hinge axis eccentric to the hinge axis of the fixed portion of the first actuator.

The movable portion of the first actuator is hinged according to a horizontal hinge axis to a rail integral without residual degrees of freedom to the fixed portion of the second actuator, and the movable portion of the second actuator is hinged to a slide which is slidably associated with the rail according to a sliding axis. The gripping body 135b is integral without residual degrees of freedom with the slide and the striker body 110 is integral without residual degrees of freedom with the rail. Furthermore, the movement axis of the first linear actuator is arranged substantially horizontally, and the movement axis of the second linear actuator is transverse to the movement axis of the first actuator, i.e. substantially vertical.

The first actuator moves the gripping body horizontally to bring it into the first position, then the second actuator moves the gripping body between the first and second positions along the extraction direction A, which in this case is vertical. In practice, by moving the gripping body horizontally with the first actuator, it is possible to orientate the actuation axis of the second actuator so as to make it parallel or coincident with the extraction direction A. In other words again, when the movable portion of the second actuator and the movable portion of the second actuator are at a predetermined distance from the fixed portion such that the first position is realised, the actuation axis of the second actuator is found to be parallel or coincident with the extraction direction A (e.g. parallel) and the movable portion of the second actuator is moved towards the fixed portion, while maintaining the movable portion of the second actuator at the distance previously reached by its fixed portion at the first position of the gripping body, in order to move between the first position and the second position along the extraction direction A. In this way, the support element is recalibrated with respect to the striker body, which remains fixed with respect to the support element. All the hinge axes described for this embodiment of the gripper unit lie on a plane perpendicular to the predetermined extraction direction A.

The gripping unit 130b is coupled with a mechanism configured to carry the portions of meat, which are handled by hanging them from the support elements and thus are arranged substantially vertically, so that the first greater face lies in a plane transverse to a vertical plane, for example it lies in a substantially horizontal plane. In the embodiment, a mechanism is illustrated which is known in the technical field as a swing, and which will therefore not be described in detail. Alternatively, a pad moved by a linear actuator along a horizontal axis can be used.

The gripping unit of the embodiment 130c is substantially that of the embodiment 130b configured to work with a vertical striker surface, and differs from the gripping unit 130a in particular because while in the embodiment 130a the striker surface is fixed to a frame to which the actuators of the striker body 130a are connected, in the embodiment 130c, as in 130b, the striker body is always fixed with respect to the gripping body, but is movable with respect to the frame with which the actuators are associated.

For the functioning of the apparatus defined so far, i.e. the different forms of apparatus defined so far, not all the characteristics of the support elements discussed above are necessary, but it is sufficient that the support element comprises:
a plurality of hooks capable of penetrating the portion of meat,
a bar to which said hooks are rigidly connected by means of a connection body comprising a first face, from which said needles rise, and a second face facing in the opposite direction to the first, and
a grasping appendage rising from the second face in at least one direction away from the first face and the second face itself.

For example, the actuation of the gripping unit 130a is used in particular where the grasping appendage comprises recesses 85, as the vertical movement of the first actuator allows a simple insertion of one hook 140a of the gripping body into the recess to accomplish the grasping, or a plurality of hooks 140a of the gripping body into the respective recesses of the grasping portion in order to accomplish the grasping. These hooks 140a are facing upwards as the recesses are facing downwards.

The unloading apparatus 40a actually has support elements according to the embodiment 45a and the gripping body comprises a plurality of hooks or pins adapted to be inserted into said recesses. However, the described drive could also be used, with minor modifications, with all the other embodiments of the support elements, including the one that requires grippers to grasp the grasping portion.

The gripping body of the embodiment 135b also comprises a hook 140b, or a plurality of hooks 140b conformed as in the embodiment 135a.

The gripping unit 130d can only be used if the support element comprises the grasping attachment with through slots or recesses. In the embodiment illustrated, this gripping unit cooperates with the support element of the embodiment indicated with 45b.

In such a case, the gripping body comprises a hook-shaped portion 140d and facing upwards obtained at a longitudinal end of the gripping body itself, at an opposite longitudinal end it is connected to a slide 144 by means of an elastic element 145, which generates a force to approach the slide of the longitudinal end to which it is connected, and in a central portion comprised between the two ends it is hinged to said slide according to a horizontal hinge axis and lying on a plane perpendicular to the predetermined extraction direction A.

In particular, the gripping body comprises a plurality of hook-shaped portions 140d.

The gripping unit then comprises a rail 146, integral without any residual degrees of freedom to the frame, with which the slide is slidably associated along a sliding axis parallel to the extraction direction.

The slide is controlled to slide with respect to the rail by a single linear actuator, which is configured to move the gripping body between the first and second position only.

The grasping appendage is grasped by moving the support element towards the second point P2 while the grasping body is already in the first position, stationary. By pushing the support element towards the second point, by means of the handling unit and/or also with the aid of a thrusting body, as will be described below, the grasping appendage contacts the end of the gripping body in which the hooks are present, causing it to rotate with respect to the hinge axis with the slide in contrast to the force exerted by the elastic element. As a result of this rotation, the hooks are brought underneath the grasping appendage and continuing the movement of the support element towards the second point, when the hooks are aligned with the through slots, thanks to the force of the elastic element working to push the hooks upwards, said hooks automatically insert themselves into the through slots, grasping the grasping appendage.

The linear drive then moves the slide to take the gripping body from the first position to the second position. The portion of meat, being blocked by the striker surface, cannot continue with the support element and consequently the hooks are removed from the portion of meat.

Irrespective of whether the apparatus implements the first or the second method, and irrespective of the characteristics of the support element, the apparatus may further comprise a thrust body 150 placed in proximity to the striker surface and selectively movable at least in a position where it prevents a movement of the support element towards the first point of the trajectory by acting on the bar, or on the ends of the bar.

In particular, in embodiments in which the striker surface lies in a vertical plane, irrespective of which method the apparatus implements, the thrust body of which is also operable, when it is in the position in which it prevents a movement of the support element towards the first point of the trajectory, towards the second point of the trajectory so as to push the support element towards said second point.

In particular, the thrust body is movable between a first position, in which it is higher than the predetermined trajectory and does not interfere with the support element, and a second position in which it intersects the predetermined trajectory and contacts the support element. When moving from the first position to the second position, the thrust body pushes the bar towards the second point of the trajectory.

In the embodiment illustrated, the thrust body is hinged to a frame of the unloading apparatus, at a point at a higher vertical height than the handling unit, i.e. the flexible components, with respect to a horizontal hinge axis and lying on a laying plane parallel to the laying plane of the striker surface. Further, said thrust body is moved by a linear actuator 155 provided with a fixed portion integral with the frame of the unloading apparatus and a movable portion, which is movable with respect to the fixed portion along a movement axis and to which an end of the thrust body is hinged eccentric with respect to the hinge axis with respect to which the thrust body is connected to the frame.

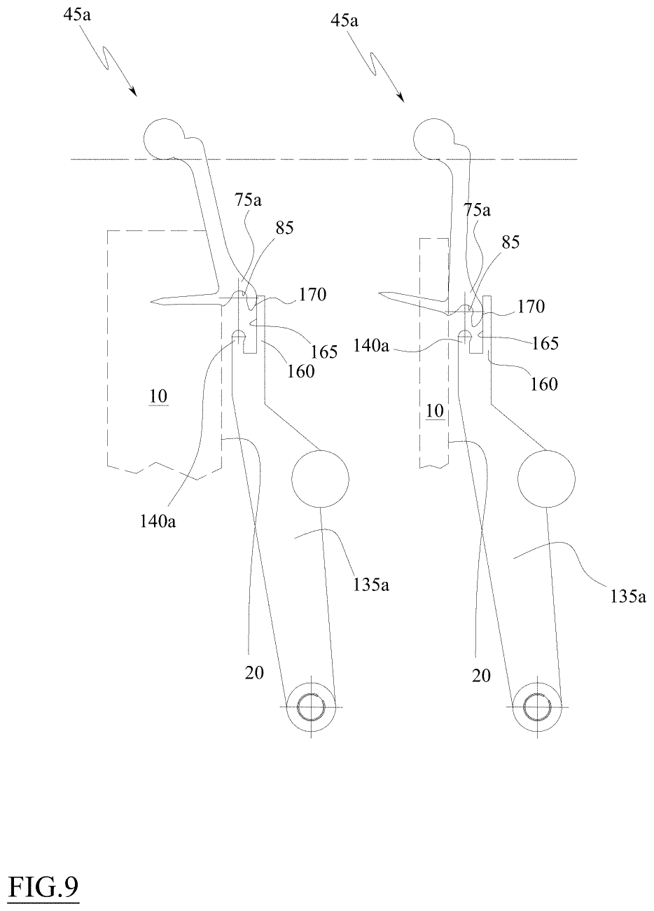

In the embodiments of the gripping body 135a,135b, the gripping body also comprises a striking body 160, see FIG. 8 and FIG. 9.

This striker body has a striker surface 165, which is flat, lying in a plane parallel to the longitudinal axis X, and facing both towards the hook of the gripping body and towards a plane perpendicular to the striker surface and passing through the first point P1.

Basically, the striker surface is located behind the hook in relation to the direction along which the support elements move from the first point to the second point.

The striker surface lies for example on a plane that is also parallel to a longitudinal axis of the hook.

The hook should preferably have a free circular end that fits into the recess. Further, in such a case, as in the embodiment 45a, the grasping appendage comprises, at its free end, a curvilinear surface 170 (see FIG. 9) with a central axis positioned at the centre of the recess and parallel to the longitudinal axis X. In such a case, the minimum distance of the striker surface 165 from a curved axis of the free end of the hook 140a (axis parallel to the longitudinal axis X) is equal to the distance of the curvilinear surface 170 of the free end of the grasping appendage from its central axis. In this way, even if the bar rotates in relation to the support surface due to portions of meat having a thickness outside a predetermined range, when the curvilinear surface touches the striker surface it is always possible to operate the hook in a direction of insertion into the recess.

In such a case, the thrust body and its actuator are configured to push the grasping appendage of the support element against the striker body (this may occur when the gripping body is in the third position). This ensures that the grasping appendage is at the predetermined distance before operating the gripper unit in the first position.

For example, the apparatus may include a sensor unit (not illustrated) configured to monitor a parameter indicative of the presence of the grasping appendage in contact with the striker body, which sensor unit is operatively connected to the electronic control and command unit, which is configured to actuate the gripping body from the third position to the first position when it detects through the sensor unit the presence of the grasping appendage in contact with the striker body.

If the striker surface lies on a horizontal plane, the thrust body is configured to retain the bar, or its ends, within the respective support elements 125, in particular in contact with the bottom surface.

In the embodiment illustrated, the thrust body is obtained as a 180 rod-shaped body and hinged to the support element.

Such characteristics of the striker surface and the thrust body, although illustrated only in apparatuses implementing the first method, may also be applied to the apparatus of the second method in the event that support elements such as those illustrated in the embodiments 45a and 45e are used in that method.

Another feature that takes advantage of the peculiarities of the support elements may be the fact that the extraction direction A is parallel to the distancing direction along which the grasping portion develops. In other words, the extraction direction is parallel to the longitudinal K axes of the needles. In particular, this parallelism refers to when the grasping appendage is grasped by the gripping body.

As mentioned above, the second method for extracting the hooks, i.e. the needles, is implemented by the unloading apparatus 40e of FIGS. 14-15. In this apparatus, the support element is held in place by grasping it by the grasping appendage, while the striker body, instead of being fixed, is moved to push the portion of meat away from the support element.

Said unloading apparatus comprises a striker body 110, which is capable of contacting, i.e. being contacted by the portion of meat 10, for example by the first greater face 20 of the portion of meat. In particular, the striker body 110 comprises a striker surface 115 adapted to be contacted by the portion of meat 10, in particular by the first greater face 20 of the portion of meat.

In the embodiments illustrated, the striker surface 115 is flat, and may lie either on a vertical plane, but it is not excluded that in an alternative embodiment it may lie on a horizontal plane.

Also in a case, not illustrated, where the grasping appendage is provided with a plurality of grasping bodies as in the embodiments 75a and 75e, the striker surface 115 would comprise a plurality of protuberances that develop along the laying plane of the striker surface 115 itself starting from an edge thereof and are configured and sized to fit into the gaps present between the grasping bodies.

The unloading apparatus 40e further comprises a handling unit 120 shaped like that of the other embodiments of the unloading apparatus in which the striker surface is vertical.

The unloading apparatus comprises a (single) gripping unit 130e located in proximity to the striker surface and provided with a (single) gripping body 135e configured to (only) grasp the grasping appendage. Obviously, there may be a plurality of gripping bodies independent from each other (i.e. operated with independent drives) and configured to grasp a single support element.

In this apparatus, the gripping unit does not comprise a drive for the gripping body 135e, because the gripping body is of the type described for the embodiment 135d, so it does not have to be brought into the third position and then into the first position to perform the grasping, and also because in this embodiment the hooks are extracted by pushing the portion of meat by moving the striker surface.

However, it is not excluded that in an alternative embodiment the gripping unit could for example be like that of embodiment 130a. In such a case, the gripping unit would comprise an actuator configured to move (cyclically or selectively), the gripping body between a first position, i.e., disengagement position, in which the gripping body does not act on the grasping appendage, and a second position, in which the gripping body is proximal to the striker surface and can grasp the grasping appendage in the transition from the first to the second position. Not having to pull the grasping appendage, there is no operating position of the gripping body in which it moves away from the first position along an extraction direction.

Returning to the embodiment illustrated 40e, in this case the striker body is associated with the frame of the unloading apparatus. In particular, the striker body is hinged along a horizontal hinge axis and parallel to the longitudinal axis X of the frame. In more detail, in such a case, the gripping body comprises a hook-shaped portion 140e and facing upwards obtained at a longitudinal end of the gripping body itself, at an opposite longitudinal end it is connected to a rail 190 rigidly integral without residual degrees of freedom to the frame of the unloading apparatus by means of an elastic element 195, which generates a force to approach the slide of the longitudinal end to which it is connected, and in a central portion comprised between the two ends is hinged to said rail according to said horizontal hinge axis.

In particular, the gripping body comprises a plurality of hook-shaped portions 140e.

The striker body 110 is movable at least with respect to the gripping body, in particular it is movable in space with respect to the frame with which the gripping unit is associated.

For example, the unloading apparatus 40e comprises an actuator 200 (linear) that moves the striker surface between a first position and a second position, wherein in said second position the striker surface is closer to the first point of the trajectory than in the first position and further away from the gripping body.

In particular, between the first and second positions, the striker body moves in a predetermined thrust direction B, e.g. straight.

The unloading apparatus therefore comprises a thrust unit 205 comprising said actuator 200 which moves the striker body 110.

For example, the thrust unit also comprises the rail 190 and a slide 210 slidably associated with the rail according to a sliding axis parallel (e.g. coincident) to the predetermined thrust direction B. The striker body is rigidly integral with the slide with no residual degrees of freedom, which slide is driven by the linear actuator sliding relative to the rail to bring the striker surface into the first and second positions.

The handling unit, the gripping unit and the thrust unit are synchronized in such a way that when, during the movement from the first point to the second point, the support element is at a predetermined distance from the third point (distance which can be zero or greater than zero), the drive of the gripping body moves the gripping body from the first position to the second position and then the thrust body is actuated to bring the striker surface from the first position to the second position.

For the functioning of the unloading apparatus 40e defined so far, i.e. the different forms of apparatus defined so far, not all the characteristics of the support elements discussed above are necessary, but it is sufficient that the support element comprises:
a plurality of hooks capable of penetrating the portion of meat,
a bar to which said hooks are rigidly connected by means of a connection body comprising a first face, from which said needles rise, and a second face facing in the opposite direction to the first, and
a grasping appendage rising from the second face in at least one direction away from the first face and the second face itself.

For example, the unloading apparatus 40e in fact has support elements according to the embodiment 45b and the gripping body comprises a plurality of hooks or pins 140e adapted to be inserted into said recesses. However, the described drive could also be used, with minor modifications, with all the other embodiments of the support elements, including that which requires grippers to grasp the grasping portion.

Another feature that takes advantage of the peculiarities of the support elements may be the fact that the thrust direction B is parallel to the distancing direction along which the grasping portion develops. In other words, the thrust direction B is parallel to the longitudinal axes K of the needles. In particular, this parallelism refers to when the grasping appendage is grasped by the gripping body.

The apparatus may also include the thrust body 150 as explained above.

The operation of the unloading apparatus according to the invention is as follows.

As an example of the different embodiments of the unloading apparatus implementing the first method, the unloading apparatus 40a will be described below according to FIGS. 1-5.

Unloading begins with the support elements already handled by the handling unit 120. In particular, the longitudinal ends of the bars of the support elements are moved over the transport surface defined by the chains of the handling unit.

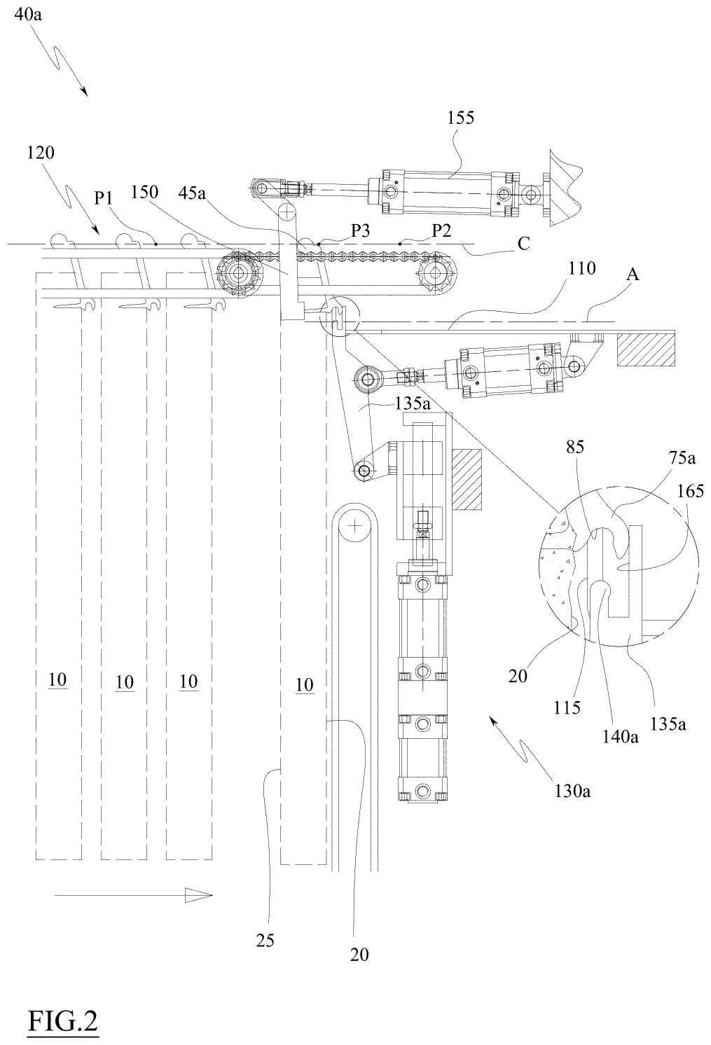

From the first point of the predefined trajectory C, the support elements are moved by acting only on the bars towards the second point P2 and just before the bar of a support element reaches the third point P3, the gripping body 135a is moved to the third position so that the grasping appendage 75a contacts the striker surface 165 (see FIG. 2).

Next, the gripping body is moved from the third position to the first position, and the grasping appendage is then grasped, i.e. the hook 140a is inserted into the recess 85 (see FIG. 3).

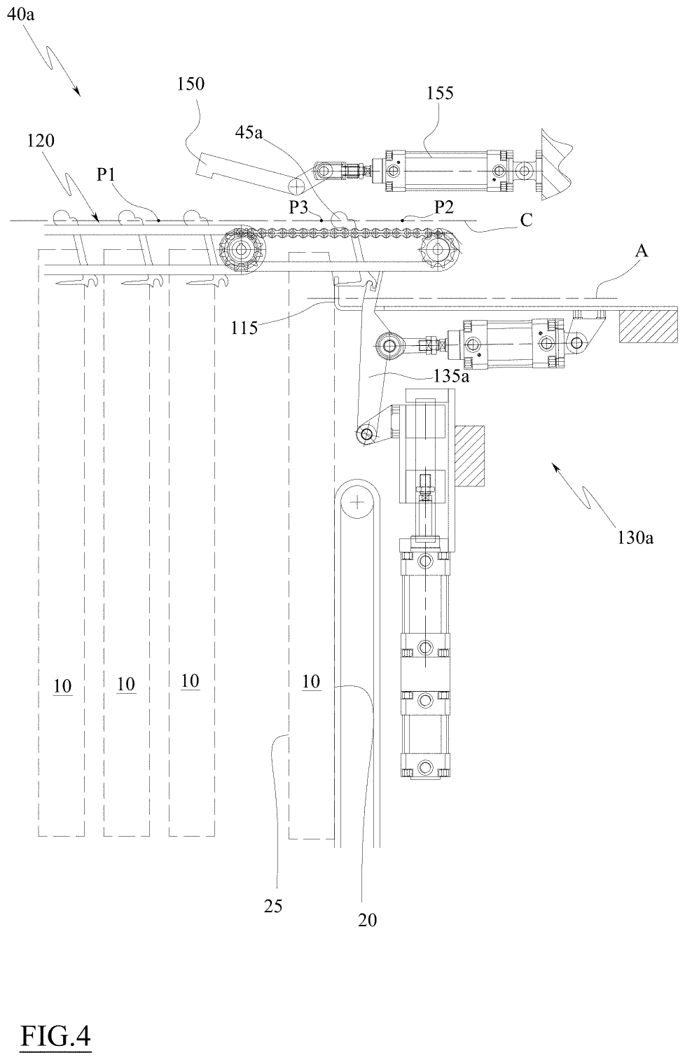

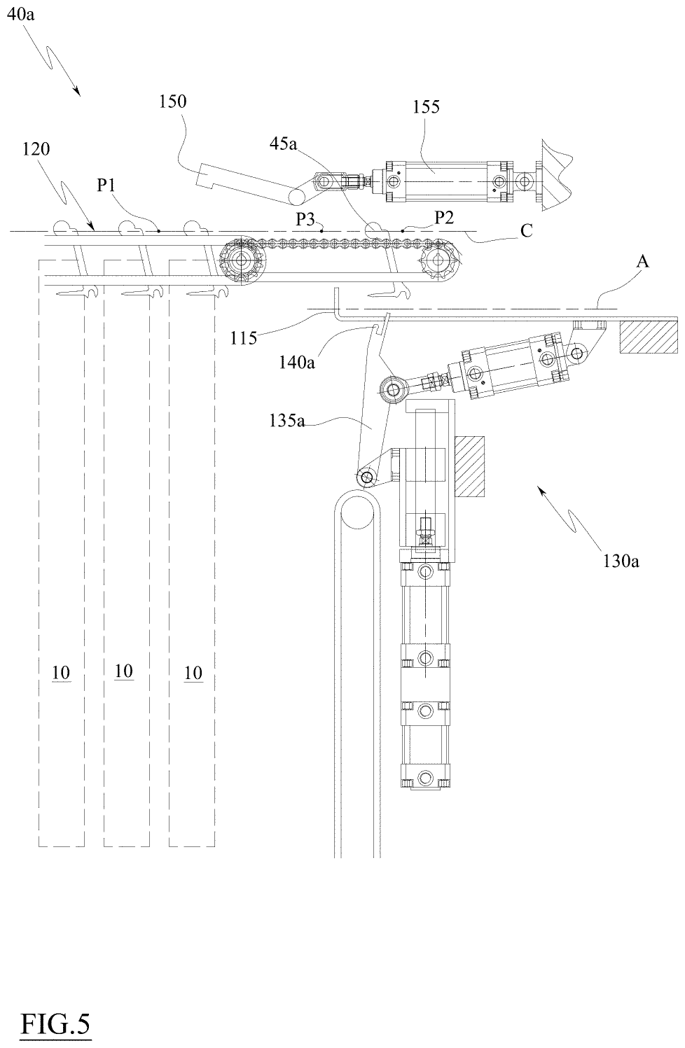

Once the hook of the gripping body is inserted, the gripping body is pulled by its drive unit along the predetermined extraction direction A, pulling with it the grasping appendage and then the support element. Since the portion of meat is unable to follow the support element along this predetermined extraction direction due to the striker surface 115 that is interposed between the portion of meat and the gripping body, the portion of meat is thus pulled out of the hooks, i.e. the needles (FIGS. 4 and 5).

In the case of unloading apparatuses comprising the gripping body hinged to a single respective drive and retained by the elastic element, such as, for example, the embodiment 40d, the main difference consists of the fact that the coupling of the support element by the gripping element takes place by advancing the support element with the drive unit and possibly thanks to the thrust body while the gripping body is already in the first position.

In the case of the unloading apparatus 40e implementing the second method, the steps are similar to those previously described, with the main difference that after the grasping (in this case, the striker surfaces are not exploited due to the shape of the support element), the grasping appendage is not pulled away from the striker surface, but it is the striker surface 115 that is pulled away from the gripping body, i.e. from the grasping appendage, which remains substantially stationary while, therefore, pushing the portion of meat by creating pressure at the first greater face 20 and thus pulling it out of the hooks, i.e. the needles.

We take this opportunity to specify that when reference is made in this discussion to an embodiment with a single or monolithic body, it is meant that the element is obtained by solidification of a single cast or injection of material in a mould (and possible subsequent processing by removal of material and/or bending).

It should also be noted that grasping a body means connecting to it in such a way as to be able to transfer a force, in this case a pulling force, to it. If the grasping body of the grasping appendage is the gripper (embodiment in which the grasping appendage is a flat, seamless plate), the grasping takes place by clamping the flat plate and transmitting the pulling force through friction.

In the case where the gripping body of the grasping appendage is the hook-shaped body (embodiments where the grasping appendage comprises recesses or slots), the grasping takes place by inserting a portion of the hook-shaped body into the recess or slot, which are generally shaped so as not to allow the hook-shaped body to slip out when the pulling force is applied, which is transmitted to the recess or slot by pressure applied by the hook-shaped body.

The invention thus conceived is susceptible to several modifications and variations, all falling within the scope of the inventive concept.

Moreover, all details can be replaced by other technically equivalent elements.

In practice, the materials used, as well as the contingent shapes and sizes, can be whatever according to the requirements without for this reason departing from the scope of protection of the following claims.

1. A support element for a portion of meat, adapted to hook said portion of meat and to allow the handling of said portion of meat, said support element comprising:
a bar developing longitudinally along a longitudinal axis (X),
a plurality of straight needles, adapted to penetrate the portion of meat, arranged with longitudinal axes (K) parallel to each other and arranged in a row parallel to the longitudinal axis (X),
a connection body connecting the straight needles to the bar and comprising a first face, from which said needles rise, and a second face facing in the opposite direction to the first face,
a grasping appendage, which rises from a portion of the second face proximal to the needles and develops both in a direction away from the first face and from the second face and in a longitudinal direction parallel to the longitudinal axis (X) of the bar,
wherein said grasping appendage is rigidly integral with the second face in at least a plurality of side-by-side sections along said longitudinal direction along which the grasping appendage develops, and
wherein there is at least one of said sections every two consecutive needles.

2. The support element according to claim 1, wherein the portion of the second face from which the grasping appendage rises is made in proximity to a plane on which the longitudinal axes (K) of the needles lie.

3. The support element according to claim 2, wherein said portion of the second face from which the grasping appendage rises intersects the laying plane of the longitudinal axes (K) of the needles.

4. The support element according to claim 1, wherein the direction away from the needles along which the grasping appendage develops is parallel to the longitudinal axes (K) of the needles.

5. The support element according to claim 1, wherein the grasping appendage comprises a plurality of through slots, or a plurality of recesses, aligned with each other along a direction parallel to the direction of the longitudinal axis (X).

6. The support element according to claim 4, wherein the plurality of through slots or the plurality of recesses are made in the grasping appendage in proximity to a plane on which the longitudinal axes (K) of the needles lie.

7. The support element according to claim 1, wherein the bar comprises a pair of opposite longitudinal ends, each of which comprises:
either a flat surface lying in a plane parallel to the longitudinal axis (X) and having a length in a direction transverse to the longitudinal axis (X) at least equal to 0.6 times the length of a needle of the plurality of needles measured along the longitudinal axis (K) of the needle,
or a pair of surfaces which lie or are tangent to a same plane parallel to the longitudinal axis (X) and are spaced apart from each other along a direction transverse to the longitudinal axis by an amount at least equal to 0.6 times the length of a needle of the plurality of needles measured along the longitudinal axis (K) of the needle,
or a pair of edges lying in the same plane parallel to the longitudinal axis (X) and spaced apart along a direction transverse to the longitudinal axis (X) by an amount at least equal to 0.6 times the length of a needle of the plurality of needles measured along the longitudinal axis (K) of the needle.

8. The support element according to claim 1, wherein the grasping appendage is made in a plurality of appendage bodies rising from the second face independently of each other.

9. The support element according to claim 8, wherein each appendage body comprises a through slot or a recess.

10. The support element according to claim 9, wherein each appendage body is aligned to a respective needle and the corresponding slot or recess of said appendage body intersects the longitudinal axis (K) of said corresponding needle.

11. The support element according to claim 1, characterized in that it is made by stamping a single sheet of sheet metal.
